(19) United States
(12) Patent Application Publication
(10) Pub. No.: US 2010/0274820 A1
(43) Pub. Date: Oct. 28, 2010

(54) SYSTEM AND METHOD FOR AUTOGENERATION OF LONG TERM MEDIA DATA FROM NETWORKED TIME-BASED MEDIA

(76) Inventors: Christopher J. O'Brien, Brooklyn, NY (US); Adrew Wason, Atlantic Highlands, NJ (US)

Correspondence Address: LACKENBACH SIEGEL, LLP, LACKENBACH SIEGEL BUILDING, 1 CHASE ROAD, SCARSDALE, NY, 10583, US

(21) Appl. No.: 12/294,680

(22) PCT Filed: Aug. 20, 2007
(86) PCT No.: PCT/US07/76339

§ 371 Date: Jun. 29, 2010

Related U.S. Application Data
(63) Continuation-in-part of application No. PCT/US07/65387, filed on Mar. 28, 2007.
Application No. PCT/US07/65387 is a continuation-in-part of application No. PCT/US07/65391, filed on Mar. 28, 2007.
Application No. PCT/US07/65391 is a continuation-in-part of application No. PCT/US07/65534, filed on Mar. 29, 2007.
Application No. PCT/US07/65534 is a continuation-in-part of application No. PCT/US07/68042, filed on May 2, 2007.

(51) Int. Cl. G06F 17/30

(52) U.S. Cl. 707/805; 707/E17.005

(57) ABSTRACT

The present invention provides an easy-to-use centralized service for providing and using advanced video and audio browsing and tagging methods to create a revised and improved video media set and for enabling a user to auto-create a fixed media form of the so-edited and so-improved video. The present invention also enables a system that allows users to select varying degrees of automated creation of a fixed media form recording following editing and revision steps potentially involving synchronized tagging and commenting aspects. Systems and operational modes are provided for labeling and formatting the auto-generated fixed media data.

### CROSS REFERENCE TO RELATED APPLICATIONS

This application relates to and claims priority from the following pending applications; PCT/US07/65387 filed Mar. 28, 2007 (Ref. Motio.P001PCT) which in turn claims priority from U.S. Prov. App. No. 60/787,105 filed Mar. 28, 2006 (Ref. Motio.P001), PCT/US07/65391 filed Mar. 28, 2007 (Ref. Motio.P002PCT) which in turn claims priority from U.S. Prov. App. No. 60/787,069 filed Mar. 28, 2006 (Ref. Motio.P002); PCT/US07/65534 filed Mar. 29, 2007 (Ref. Motio.P003PCT) which in turn claims priority from U.S. Prov. App. No. 60/787,393 filed Mar. 29, 2006 (Ref. Motio.P003); U.S. Prov. App. No. 60/822,925 filed Aug. 18, 2006 (Ref. Motio.P004), PCT/US07/68042 filed May 2, 2007 (Ref. Motio.P005PCT which in turn claims priority from U.S. Prov. App. No. 60/746,193 filed May 2, 2006 (Ref. Motio.P005), and U.S. Prov. App. No. 60/822,927 filed Aug. 19, 2006 (Ref. Motio.P006), the contents of each of which are fully incorporated herein by reference.

### FIGURE SELECTED FOR PUBLICATION

FIG. 11

### BACKGROUND OF THE INVENTION

1. Field of the Invention

The present invention relates to a system, method, and apparatus for enabling users to initiate an autogeneration of a durable storage medium from interactive video media data and associated metadata. More specifically, the present invention relates a system for enabling a consumer to determine and record selected, preferred, and specific autogeneration parameters prior to a step of fixing selected interactive video media data and associated metadata in a durable storage medium. Additionally, the system causes such durable storage media to be created without changing the initially secured and underlying video data or associated metadata and provides a series of user interfaces, an underlying program module, and a supportive data module within a cohesive operating system to enable the same.

2. Description of the Related Art

The current state of the art allows a user to upload a video to a web site or to deliver the video encoded on physical media to a physical location whereupon a service will be provided to create a DVD reproducing the video as provided. (The term DVD is used herein as representative of a class of permanent storage and playback media suitable for video-like media, especially digitally encoded video with synchronized audio and associated synchronized metadata.) Additional basic features may be offered such as adding a title and a basic cover including the title and producer name. No editing capabilities are provided but are “assumed” to have been performed by the producer herself. No detailed metatags, comments, or other critical details are included. Video and audio enhancement are potentially available but such enhancement appears available only to professional producers at very high prices.

Since the current state of the art does not have the server-based, video edit/virtual browse/deep tag/synchronized comment capabilities coupled with the data model and playback decision lists (PDLs) disclosed in Applicant's accompanying patent applications, it is not possible for the previously known state of the art to offer such services to be incorporated into the DVD production without the introduction of expert human services. Such introduction places the cost of such a service beyond the practical reach of the vast majority of consumers.

The present invention described herein makes full use of the powerful video edit/virtual browse/deep tag/synchronized comment/interest intensity measurement/social browse capabilities of Applicant's related applications coupled with the data model and PDL described in the accompanying patent applications (all incorporated by reference) thereby enabling creation of DVDs or similar fixed-form permanent media with little or no human intervention. Therefore DVDs which incorporate these features which enhance viewing interest can be produced at a cost appropriate to the consumer market. At present this capacity does not exist in non-Applicant related art.

People who have shot videos and/or collected videos shot by others often wish to have permanent copies of such videos on permanent media such as DVDs created in a convenient manner. That desire is enhanced when the videos have been enhanced by the capabilities of editing, tagging and synchronized commenting described in a manner below and in Applicant's related applications noted above. Such media are of special value to those who do not have high-speed Internet connections or who wish to view these videos on traditional television sets.

Unfortunately, while many consumer PCs are capable of “burning” DVDs, in practice creating a video DVD that is pleasant to watch and which is compatible with commercial DVD players and traditional television sets is not a simple exercise for most non-expert consumers. Simply leaving copies of video files on a PC may not be attractive to many consumers because the files are large and can be difficult to organize and, as discussed in previous, referenced applications, very difficult to edit into a form which is pleasant to view.

Unfortunately, the related art has also failed to recognize that consumers may want to take advantage of the advanced video and audio enhancement techniques available in the marketplace without having to purchase and become skilled in the use of the software and/or hardware required to implement these techniques for themselves. The present application proposes a centralized service to overcome this difficulty and offers the benefits of these techniques to a wide audience.

As related background, consumers are shooting more and more personal video using camera phones, webcams, digital cameras, camcorders and other devices, but consumers are typically not skilled videographers nor are they able or willing to learn complex, traditional video editing and processing tools like Apple iMovie or Windows Movie Maker. Nor are most users willing to watch most video “VCR-style”, that is in a steady steam of unedited, undirected, unlabeled video.

Thus consumers are being faced with a problem that will be exacerbated as both the number of videos shot and the length of those videos grows (supported by increased processing speeds, memory and bandwidth in end-user devices such as cell phones and digital cameras) while the usability of editing tools lags behind. The result will be more and longer video files whose usability will continue to be limited by the inability to locate, access, label, discuss, and share granular sub-segments of interest within the longer videos in an overall library of videos.

In the absence of editing tools for the videos, adding titles and comments to the videos as a whole does not adequately address the difficulty. For example, there may be only three 15-second segments of interest scattered throughout a 10 minute long, unedited video. A special problem is that distinct viewers may find distinct 15-second intervals of interest.

The challenge faced by viewers is to find those few short segments of video which are of interest to them at that time without being required to scan through the many sections which are not of interest.

The reciprocal challenge is for users to help each other find those interesting segments of video. As evidenced by the broad popularity of chat rooms, blogs etc. viewers want a forum in which they can express their views about content to each other, that is, to make comments. Due to the time-based nature of the video, expressing interest levels, entering and tracking comments and/or tags or labels on subsegments in time of the video or other time-based media is a unique and previously unsolved problem. Based on the disclosure herein, those of skill in the art should recognize that such time-variant metadata has properties very different from non-time-variant metadata and will require substantially distinct means to manipulate and manage it.

Additional challenges described in Applicant's incorporated references apply equally well here including especially:

a. the fact that video and accompanying audio is a time-dependent, four dimensional object which needs to be viewed, manipulated and managed by users on a two-dimensional screen when time is precious to the user who does not wish to watch entire, unedited videos (discussed in detail below with regard to the special complexities of digitally encoded video with synchronized audio (DEVSA) data);

b. the wide diversity of capabilities of the user devices which users wish to use to watch such videos ranging from PCs to cell phones (as noted further below); and

c. the need for any proposed solution to be able to be structured for ready adaptation and re-encodation to accommodate the rapidly changing capabilities of the end-user devices and of the networks which support them.

Those with skill in the art should recognize the more generic terminology “time-based media” which encompasses not only video with synchronized audio but also audio alone plus also a range of animated graphical media forms ranging from sequences of still images to what is commonly called ‘cartoons’. All of these forms are addressed herein. The terms, video, time-based media, and digitally encoded video with synchronized audio (DEVSA) are used as terms of convenience within this application with the intention to encompass all examples of time-based media.

A further detriment to the consumer is that video processing uses a lot of computer power and special hardware often not found on personal computers. Video processing also requires careful hardware and software configuration by the consumer. Consumers need ways to edit video without having to learn new skills, buy new software or hardware, become expert systems administrators or dedicate their computers to video processing for great lengths of time.

Consumers have been limited to editing and sharing video that they could actually get onto their computers, which requires the right kind of hardware to handle their own video, and also requires physical movement of media and encoding if they wish to use video shot by another person or which is taken from stock libraries.

When coupled with the special complexities of digitally encoded video with synchronized audio the requirements for special hardware, difficult processing and storage demands combine to reverse the common notion of using “free desktop MIPS and GBs” to relieve central servers. Unfortunately, for video review and editing the desktop is just is not enough for most users. The cell phone is certainly not enough, nor is the personal digital assistant (PDA). There is, therefore, a need for an improved method and system for shared viewing and editing of time-based media.

Those with skill in the conventional arts will readily understand that the terms “video” and “time-based media” as used herein are terms of convenience and should be interpreted generally below to mean DEVSA including content in which the original content is graphical.

This application addresses a unique consumer and data model and other systems that involve manipulation of time-based media. As introduced above, those of skill in the art reviewing this application will understand that the detailed discussion below addresses novel methods of receiving, managing, storing, manipulating, and delivering in the form of permanent media such as DVDs, digitally encoded video with synchronized audio and synchronized metadata.

In order to understand the concepts provided by the present, and related inventions, those of skill in the art should understand that DEVSA data is fundamentally distinct from and much more complex than data of those types more commonly known to the public and the broad data processing community and which is conventionally processed by computers such as basic text, numbers, or even photographs, and as a result requires novel techniques and solutions to achieve commercially viable goals (as will be discussed more fully below).

Techniques (editing, revising, compaction, etc.) previously applied to these other forms of data types cannot be reasonably extended due to the complexity of the DEVSA data, and if commonly known forceful extensions are orchestrated they would
Be ineffective in meeting users' objectives and/or
Be economically infeasible for non-professional users and/or
Make the so-rendered DEVSA data effectively inoperable in a commercially realistic manner.

Therefore a person skilled in the art of text or photo processing cannot easily extend the techniques that person knows to DEVSA.

What is proposed for the present invention is a new system and method for managing, storing, manipulating, editing, operating with and delivering, etc. DEVSA data and novel kinds of metadata associated with, linked to and, in many cases, synchronized with said DEVSA. As will be discussed herein the demonstrated state-of-the-art in DEVSA processing suffers from a variety of existing, fundamental challenges associated with known DEVSA data operations. The differences between DEVSA and other data types and the consequences thereof are discussed in the following paragraphs. These challenges affect not only the ability to manipulate the DEVSA itself but also manipulate associated metadata linked to the internals of the DEVSA. Hence those of skill in the art not only face the challenges associated with dealing with DEVSA but also face the challenges of new metadata forms such as deep tagging, synchronized commenting, visual browsing and social browsing as discussed herein and in Applicant's related applications.

This application does not address new techniques for digitally encoding video and/or audio or for decoding DEVSA. There is substantive related art in this area that can provide a basic understanding of the same and those of skill in the electronic arts know these references. Those of skill in the art will understand however that more efficient encoding/decoding to save storage space and to reduce transmission costs only serves to greatly exacerbate the problems of operating on DEVSA and having to re-save revised DEVSA data at each step of an operation if the DEVSA has been decoded to perform any of those operations.

A distinguishing point about video and, by extension stored DEVSA, is to emphasize that video or stored DEVSA represents an object with four dimensions: X, Y, A-audio, and T-time, whereas photos can be said to have only two dimensions (X, Y) and can be thought of as a single object that has two spatial dimensions but no time dimension. The difficulty in dealing with mere two dimensional photo technology is therefore so fundamentally different as to have no bearing on the present discussion (even more lacking are text art solutions).

Another distinguishing point about stored DEVSA that illustrates its unique difficulty in editing operations is that it extends through time. For example, synchronized (time-based) comments are not easily addressed or edited by subsequent users using previously known methods without potential corruption of the DEVSA files and substantial effort costly to the process on a commercial scale.

Those with skill in the art should be aware of an obvious example of the challenges presented by this time dependence in that it is common for Internet users to post comments on Web sites about specific news items, text messages, photos or other objects which appear on Web sites. The techniques for doing so are well known to those with skill in the art and are commonly used today. The techniques are straightforward in that the comment is a fixed, single data object and the object commented upon is a fixed, single data object. However the corollaries in the realm of time-based media are not well known and not supported within the current art.

As an illustrative example, consider the fact that a video may extend for five minutes and encompass 7 distinct scenes addressing 7 distinct subjects. If an individual wishes to comment upon scene 5/subject 5, that comment would make no sense if it were tied to the video as a whole. It must be tied only to scene 5 that happens to occur from 3 minutes 22 seconds until 4 minutes 2 seconds into the video.

Since the video is a time-based data object, the comment must also become a time-based data object and be linked within the time space of the specific video to the segment in question. Such time-based comments and such time-dependent linkages are not known or supported within the related arts but are supported within this model.

A stored DEVSA represents an object with four dimensions: X, Y, A, T: large numbers of pixels arranged in a fixed X-Y plane which vary smoothly with T (time) plus A (audio amplitude over time) which also varies smoothly in time in synchrony with the video. For convenience video presentation is often described as a sequence of “frames” (such as 24 frames per second). This is however a fundamentally arbitrary choice (number of “frames” and use of “frame” language) and is a settable parameter at encoding time. In reality the time variance of the pixel's change with time is limited only by the speed of the semiconductors (or other electronic elements) that sense the light.

Before going further it is also important for those of skill in the art to fully appreciate the scale of these DEVSA data elements that sets them apart from text or photo data elements, and why this scale is so extremely difficult to manage. As a first example, a 10-minute video at 24 “frames” per second would contain 14,400 frames. At 600×800 pixel resolution, 480,000 pixels, one approaches 7 billion pixel representations.

When one adds in the fact that each pixel needs 10- to 20 bits to describe it and the need to simultaneously describe the audio track, there is a clear and an impressive need for an invention that addresses both the complexity of the data and the fact that the DEVSA represents not a fixed, single object rather a continuous stream of varying objects spread over time whose characteristics can change multiple times within a single video. To date no viable solutions have been provided which are accessible to the typical consumer, other than very basic functions such as storing pre-encoded video files, manipulating those as fixed files, and executing START and STOP play commands such as those on a video tape recorder.

While one might have imagined that photos and video offer similar technical challenges, the preceding discussion makes it clear again that the difficulties in dealing with mere two dimensional photos which are fixed in time are therefore so fundamentally different and less challenging as to have no bearing on the present discussion. The preceding sentence applies at least as strongly to the issue of metadata associated with DEVSA. A tag, comment, etc. on an object fixed in time such as a text document or a picture or a photo are well-understood objects (metadata in a broad sense) with clear properties. The available technology has made such things more accessible but has not really changed their nature from that of the printed word on paper: fixed comment tied to fixed object.

In this and Applicant's related applications an emphasis is placed on metadata including tags, comments, visual browsing and social browsing information which are synchronized to the internal time-line of the DEVSA including after the DEVSA has been “edited”, all without changing the DEVSA.

By way of background information, some additional facts about DEVSA should be well understood by those of skill in the art; and these include:
a. Current decoding technology allows one to select any instant in time within a video and resolve a “snapshot” of that instant, in effect rendering a photo of that instant and to save that rendering in a separate file. As has been shown, for example in surveillance applications, this is a highly valuable adjunctive technology but it fails to address the present needs.
b. It is not possible to take a “snapshot” of audio, as a person perceives it. Those of skill in the electronic and audio-electronic arts recognize that audio data is a one dimensional data type: (amplitude versus time). It is only as amplitude changes with time that it is perceivable by a person. Electronic equipment can measure that amplitude if desired for special reasons.

The present application and those related family applications apply to this understanding of DEVSA when the actual video and audio is compressed (as an illustration only) by factors of a thousand or more but remain nonetheless very large files. Due the complex encoding and encodation techniques employed, those files cannot be disrupted or manipulated without a severe risk to the inherent stability and accuracy of the underlying video and audio content. This explains in part the importance of keeping metadata and DEVSA as separate, linked entities.

The conventional manner in which users edit digitized data, whether numbers, text, graphics, photos, or DEVSA, is to display that data in viewable form, make desired changes to that viewable data directly and then re-save the now-changed data in digitized form.

The phrase above, “make desired changes to that viewable data”, could also be stated as “make desired changes to the manner in which that data is viewed” because what a user “views” changes because the data changes, which is the normative modality. In contrast to this position, the proposed invention changes the viewing of the data without changing the data itself. The distinction is material and fundamental.

In conventional data changes, where storage cost is not an issue to the user, the user can choose to save both the original and the changed version. Some sophisticated commercial software for text and number manipulation can remember a limited number of user-changes and, if requested, display and, if further requested, may undo prior changes.

This latter approach is much less feasible for photos than for text or numbers due to the large size and the extensive encoding required of photo files. It is additionally far less feasible for DEVSA than for photos because the DEVSA files are much larger and because the DEVSA encoding is much more complex and processor intensive than that for photo encoding.

In a similar analysis, the processing and storage costs associated with saving multiple old versions of number or text documents is a small burden for a typical current user. However, processing and storing multiple old versions of photos is a substantial burden for typical consumer users today. Most often, consumer users store only single compressed versions of their photos. Ultimately, processing and storing multiple versions of DEVSA is simply not feasible for any but the most sophisticated users even assuming that they have use of suitable editing tools.

As will be discussed, this application proposes new methodologies and systems that address the tremendous conventional challenges of editing heavily encoded digitized media such as DEVSA and in parallel and in conjunction proposes new methodologies and systems to gather, analyze, store, distribute, display, etc. new forms of metadata associated with said DEVSA and synchronized with said DEVSA in order to provide new systems, processes and methods for such DEVSA and metadata to enhance the use thereof.

A parallel problem, known to those with skill in the conventional arts associated with heavily encoded digitized media such as DEVSA, is searching for content by various criteria within large collections of such DEVSA.

Simple examples of searching digitized data include searching through all of one's accumulated emails for the text word “Anthony”. Means to accomplish such a search are conventionally known and straight-forward because text is not heavily encoded and is stored linearly. On the Internet, companies like Google and Yahoo and many others have developed and used a variety of methods to search out such text-based terms (for example “Washington's Monument”). Similarly, number-processing programs follow a related approach in finding instances of a desired number (for example the number “$1,234.56”).

However, when the conventional arts approach digitally encoded graphics or, more challengingly, digitally encoded photos, and far more challengingly, DEVSA, managing the problem becomes increasingly difficult because the object of the search becomes less and less well-defined in terms, (1) a human can explain to a computer, and (2) a computer can understand and use algorithmically. Moreover, the data is ever more deeply encoded as one goes from graphics to photos to DEVSA.

Conventional efforts to employ image recognition techniques for photos and video, and speech recognition techniques for audio and video/audio, require that the digitized data be decoded back to viewable/audible form prior to application of such techniques. As is well known to those of skill in the art, repetitive encoding/decoding with edits introduces substantial risks for graphical, photographic, audio and video data.

As an illustrative example of the substantial challenges of searching, consider the superficially simple graphics search question: “Search the file XYZ graph which includes 75 figures and find all the elements which are “ovals”.

If the search is being done with the same software which created the original file and it is a purely graphical file, the search may be possible. However, if the all the user has are images of the figures, the challenges are substantial. To name a few:
1. The user and the computer first have to agree on what “oval” means. Consider the fact that circles are “ovals” with equal major and minor axes.
2. The user and computer have to agree if embedded figures such as pictures or drawings of a dog should be included in the search since the dog's eyes may be “oval”.
3. The user and computer have to agree if “zeros” and/or “O's” are ovals or just text.

The point is that recognizing shapes gets tricky.

Turning to photos, unless there are metadata names or tags tied to the photo, which explain the content of the photo, determining the content of the photo in a manner susceptible to search is a largely unsolved problem outside of very specialized fields such as police ID photos. Distinguishing a photo of Mt. Hood from one of Mt. Washington by image recognition is extremely difficult for a computer.

Extensions of recognition technologies to video are potentially valuable but are even more difficult due to the complexities of DEVSA described previously. Thus, solutions to the problems noted are extremely difficult to comprehend, and are not available through consumer-accessible resources.

This application proposes new methods, systems, and techniques to enable and enhance using, editing and searching of DEVSA files via use of novel types of metadata and novel types of user interactions with integrated systems and software. Specifically relate to the distinction made above, this application addresses methods, systems and operational networks that provide the ability to change the manner in which users view and use digitized data, specifically DEVSA, without necessarily changing the underlying digitized data.

Those of skill in the art will recognize that there has been a tremendous commercial and research demand to cure the long-felt-problem of data loss where manipulating the underlying DEVSA data in situ.

Repetitive encoding and decoding cycles are very likely to introduce accumulating errors with resultant degradation to the quality of the video and audio. Therefore there is strong demand to retain copies of original files in addition to re-encoded files. Since, as stated previously, these are large files even after efficient encoding, economic pressures make it very difficult to keep many copies of the same original videos. Conversely, efficient encoding, to reduce storage space demands, requires large amounts of computing resources and takes an extended period of time to complete.

Thus, the related art in video editing and manipulation favors light repetitive encoding which in turn uses lots of storage but requires keeping more and more copies of successive versions of the encoded data to avoid degradation thus requiring even more storage. Conversely, when no editing is planned, heavy encoding is utilized to reduce storage needs. As a consequence, those of skill in the art will recognize a need to overcome the particular challenges presented by the current solutions to manipulation of encoded time-based media.

As an illustrative example only, those of skill in the art should recognize the below comparison between DEVSA and other somewhat related data types.

The most common data type on computers (originally) was or involved numbers. This problem was well solved in the 1950s on computers and as a material example of this success one can buy a nice calculator today for $9.95 at a local non-specialty store. As another example, both Lotus® and now Excel® software systems now solve most data display problems on the desktop as far as numbers concerned.

Today the most common data type on computers is text. Text is a one-dimensional array of data: a sequence of characters. That is, the characters have an X component (no Y or other component). All that matters is their sequence. The way in which the characters are displayed is the choice of the user. It could be on an 8×10 inch page, on a scroll, on a ticker tape, in a circle or a spiral. The format, font type, font size, margins, etc. are all functions added after the fact easily because the text data type has only one dimension and places only one single logical demand on the programmer, that is, to keep the characters in the correct sequence.

More recently a somewhat more complex data type has become popular, photos or images. Photos have two dimensions: X and Y. A photo has a set of pixels arranged in a fixed X-Y plane and the relationship among those pixels does not change. Thus, those of skill in the art will recognize that the photo can be treated as a single object, fixed in time and manipulated accordingly.

While techniques have been developed to allow one to “edit” photos by cropping, brightening, changing tone, etc., those techniques require one to make a new data object, a new “photo” (a newly saved image), in order to store and/or retrieve this changed image. This changed image retains the same restrictions as the original: if one user wants to “edit” the image, the user needs to change the image and re-save it. It turns out that there is little “size”, “space”, or “time” penalty to that approach to photos because, compared to DEVSA, images are relatively small and fixed data objects.

In summary, DEVSA should be understood as a type of data with very different characteristics from data representing numbers, text, photos or other commonly found data types. Recognizing these differences and their impacts is fundamental to the proposed invention. As a consequence, an extension of ideas and techniques that have been applied to those other, substantially less complex data types have no corollary to those conceptions and solutions noted below. The present invention provides a new manner of (and a new solution for) dealing with DEVSA type data that both overcomes the detriments represented by such data noted above, and results in a substantial improvement demonstrated via the present system and method.

The present invention also recognizes the earlier-discussed need for a system to manage and use DEVSA data in a variety of ways while providing extremely rapid response to user input without changing the underlying DEVSA data.

What is also needed is a new manner of dealing with DEVSA that overcomes the challenges inherent in such data and that enables immediate and timely response to DEVSA data, and especially that DEVSA data and time-based media in general that is amended-or-updated on a continual or rapidly changing basis. What is not appreciated by the related art is the fundamental data problem involving DEVSA and current systems for manipulating the same in a consumer responsive manner with an integrated capability to capture and record the resultant interactive video, synchronized audio and synchronized metadata on permanent media.

What is also not appreciated by the related art is the need for providing a data model that accommodates (effectively) all present modern needs involving automated creation of interactive time-based media recorded on permanent media.

Accordingly, there is a need for an improved system and data model for automated creation of interactive time-based media recorded on permanent media.

What is also needed by those of skill in the art is the need for a new manner of utilizing the metadata generated from multi-user, social browsing types of interactions to contribute to the creation of interactive permanent media without changing an underlying video media content and which takes into account the time-variant nature of the incorporated metadata.

Accordingly, there is a need for an improved system and method for customized, user-driven automated creation of permanent media of selected time-based media and associated metadata which incorporates interactive features analogous to those accessible via a Web site controlled by Applicant's referenced applications and analogous to those found on commercially produced DVDs.

### SUMMARY OF THE INVENTION

The present invention proposes a response to the detriments noted above.

Another aspect of this invention is to provide extremely easy-to-use web-based tools for autogeneration of long term media storage modes from interactive media data.

Another desire of the invention includes an editing capability that includes, but is not limited to, functions such as abilities to add video titles, comments and labels for sub-segments in time of the video, lighting transitions and other visual effects as well as interpolation, smoothing, cropping and other video processing techniques, both under user-control and automatically, and to thereafter provide a capacity to begin an autogeneration sequence to receive the so-edited video data in a convenient fixed form ready for permanent media generation.

It is another aspect of the present invention to provide an improved video operation system with improved user-interaction over the Internet for autogeneration of fixed storage of video media previously subjected to a consumer editing process.

It is another aspect of the invention to utilize, to the degree desired by the user, social browsing information including tags, synchronized comments and interest intensity data as described in Applicant's referenced applications, to further enhance the usability and value of the video and associated metadata which will be incorporated into the permanent media.

One primary aspect of the invention is to provide a desirable service to consumers, which is to create a DVD (or analogous permanent medium) of consumer-selected videos.

A further desire is that such a DVD would make full use of all the information created by use of the disclosures in Applicant's related applications in a substantively automated manner wherein a fixed recorded media contains not only the desired edited video but also associated metadata including synchronized indices, tags, comments, menus, time lines, interest intensity data and other “usability aids” which, taken together, will make the resultant DVD of greater value to the consumer.

A further desire is to provide an operational system that empowers a consumer to choose videos (and portions thereof) to include in a fixed form recording.

A further desire is to provide a system and method wherein a consumer following video manipulation choices may employ varying degrees of automated creation of a fixed recording media.

A further desire is to provide an operation system and method wherein the consumer may review edited results, accept or reject parts or all of the results and, at the point of user satisfaction, may instruct the system to proceed to create and ship one or more copies of the video media in a fixed form.

A further desire is to make use of the customer name, the images, titles, tags, etc. associated with the videos and such other information the user may choose to create and print a customized cover and printed inserts for the DVD.

A further desire is to employ video and audio enhancement techniques to produce improved quality video and audio for encoding on the DVD or analogous medium.

A further desire is that an option would be to have the system manage or provide sufficient information to the consumer's PC or other end-user device to bum one or more copies of the fixed media.

A further desire is that an option would be to have the system manage or provide sufficient information to the consumer's PC or other end-user or third-party device to burn one or more copies of the fixed media not including all or part of the DEVSA which may have been stored on the end-user's device or some other device operated by a third or fourth party.

A further desire is that because it is likely that fees would be charged for such a service, measurements of activities performed will be tracked and normal billing activities incorporated into the process.

The present invention relates to a centralized service for providing and using advanced video and audio enhancement methods to create a revised video and audio media set and for enabling a user to auto-create a fixed form of the so-edited and so-enhanced video and audio. The present invention also enables a system that allows users to selected varying degrees of automated creation of a fixed form recording media following editing and revision steps. Systems and operational modes are provided for conveniently labeling and formatting the auto-generated media data.

### BRIEF DESCRIPTION OF THE DRAWINGS

FIG. 1 represents an illustrative flow diagram for an operational system and architectural model for one aspect of the present invention.

FIG. 2 represents an illustrative flow diagram of an interactive system and data model for shared viewing and editing of encoded video or other time-based media enabling a smooth interaction between a video media user and the underlying stored DEVSA data along with linked metadata.

FIG. 3 is an illustrative flow diagram for a web-based system for enabling and tracking editing of personal video content.

FIG. 4 is a screen image of the first page of a user's list of the user's uploaded video data.

FIG. 5 is a screen image of edit and data entry page allowing a user to “add” one or more videos to a list of videos to be edited as a group.

FIG. 6 is a screen image of an “edit” and “build” step using the present system.

FIG. 7 is a screen image of an edit display page noting three videos successively arranged in text-like formats with thumbnails roughly equally spaced in time throughout each video. The large image at upper left is a ‘blow-up’ of the current thumbnail.

FIG. 8 is a screen image of a partially edited page where selected frames with unwanted video have been “cut” by the user via ‘mouse’ movements.

FIG. 9 is a screen image of the original three videos where selected images of a “pool cage” have been “cut” during a video edit session. The user is now finished editing.

FIG. 10 is a screen image of the first pages of a user list of uploaded video data. The original videos have not been altered by the editing process.

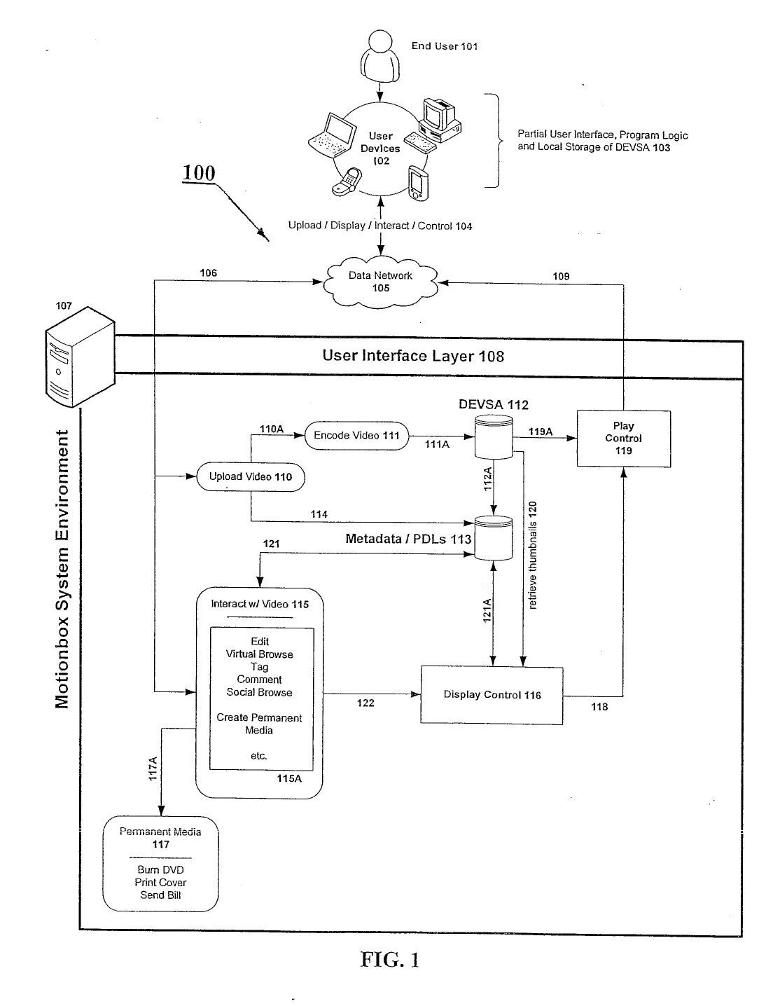

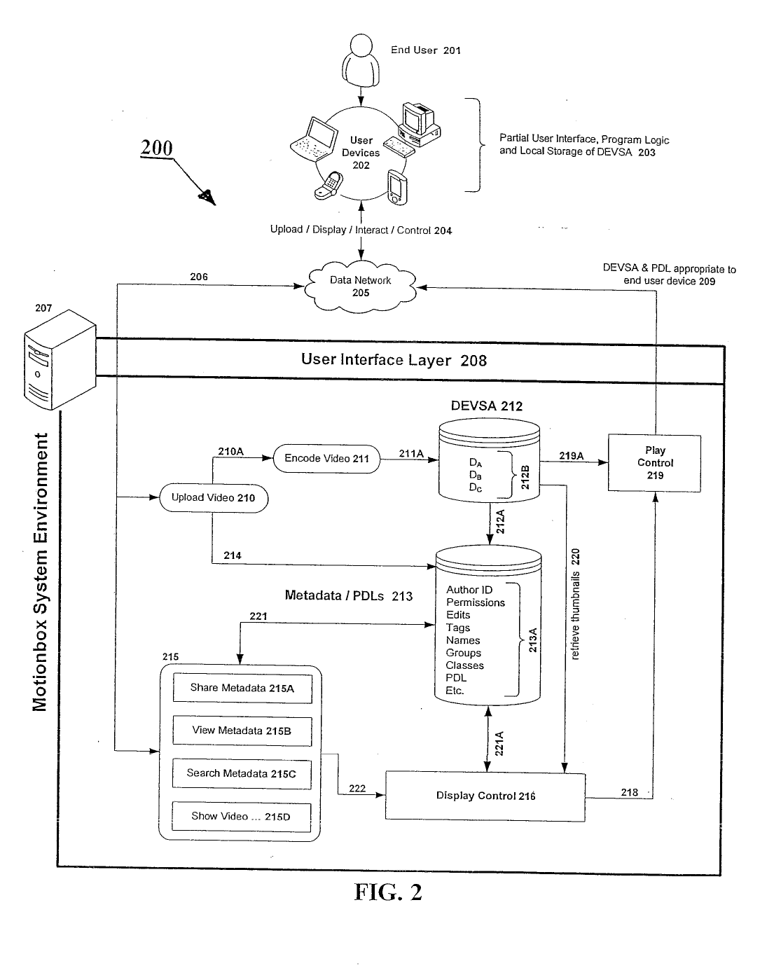

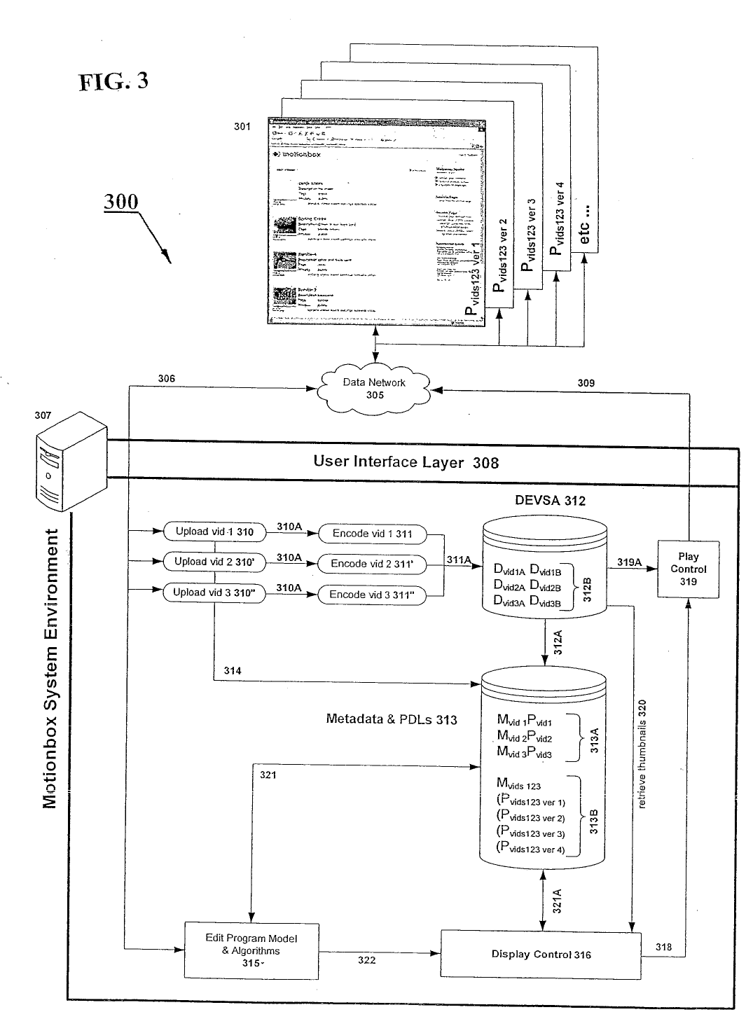

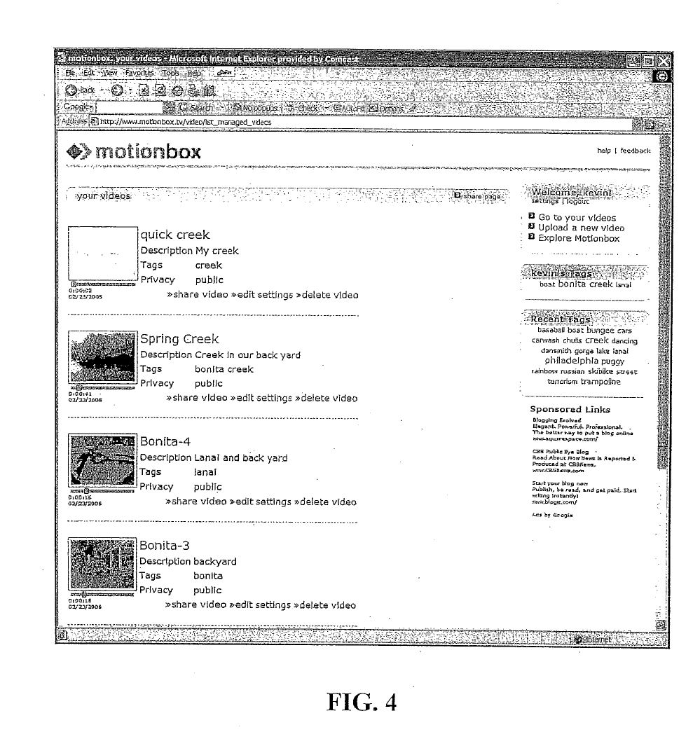

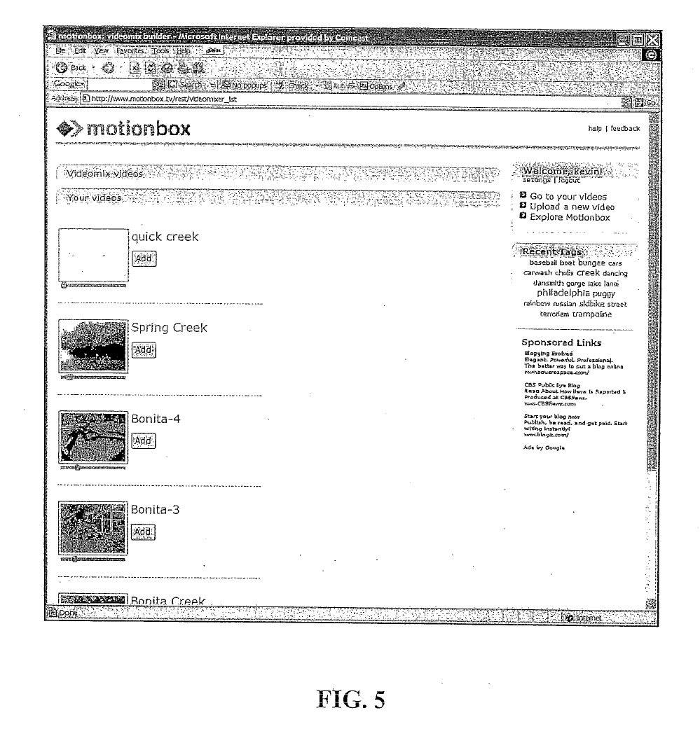

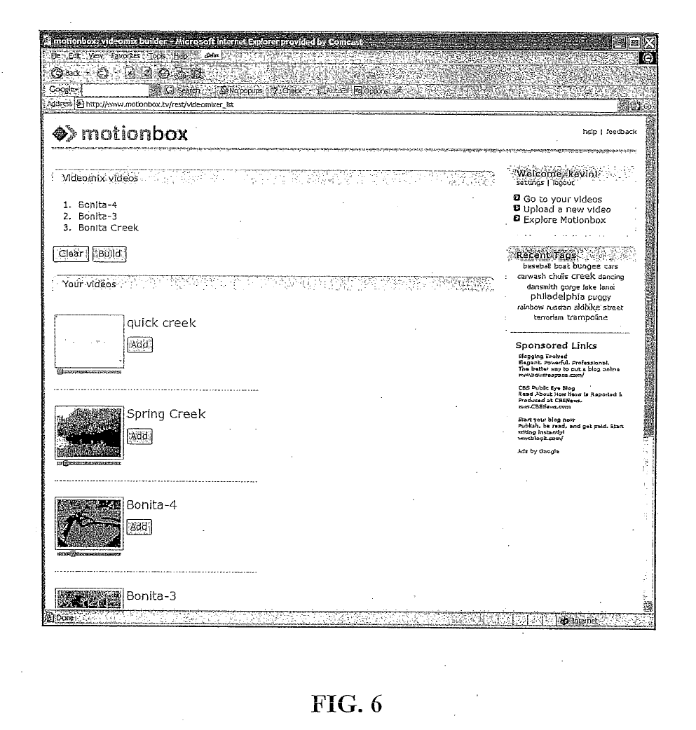

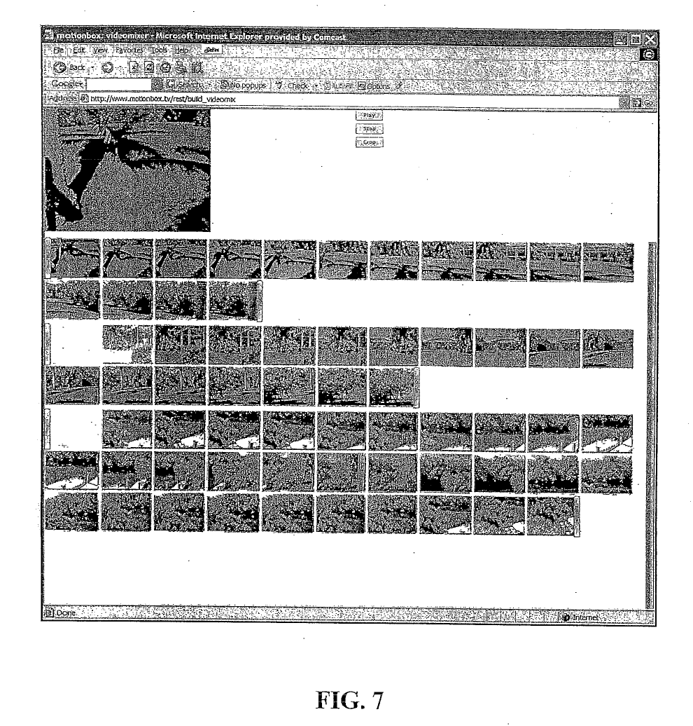

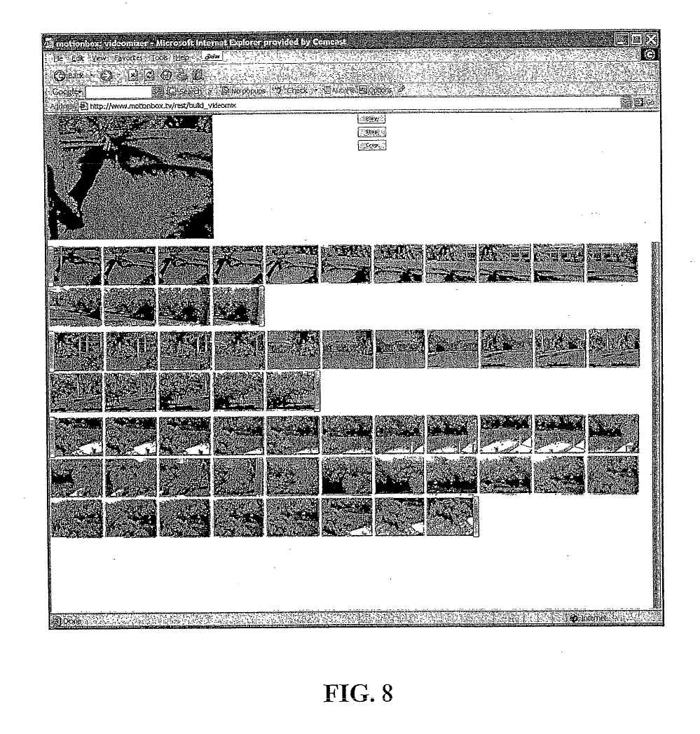

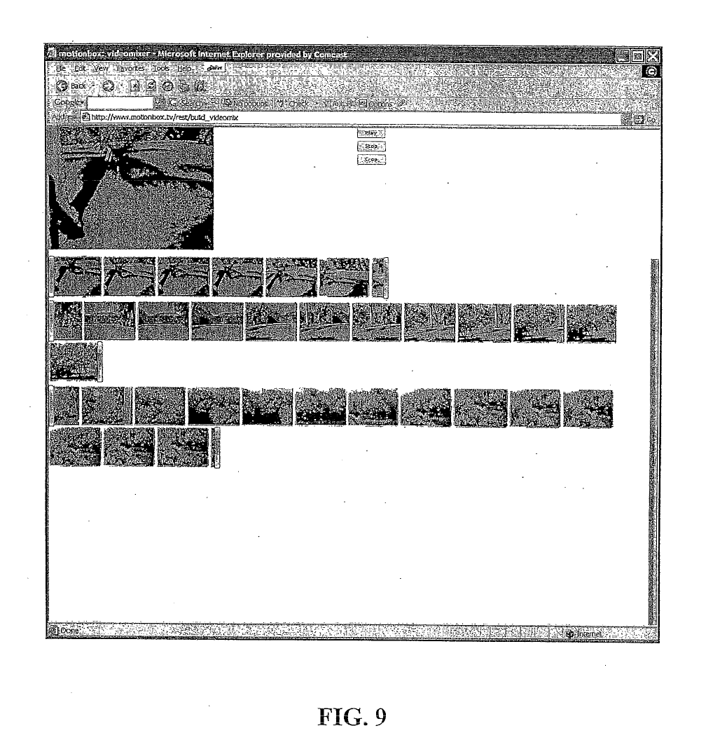

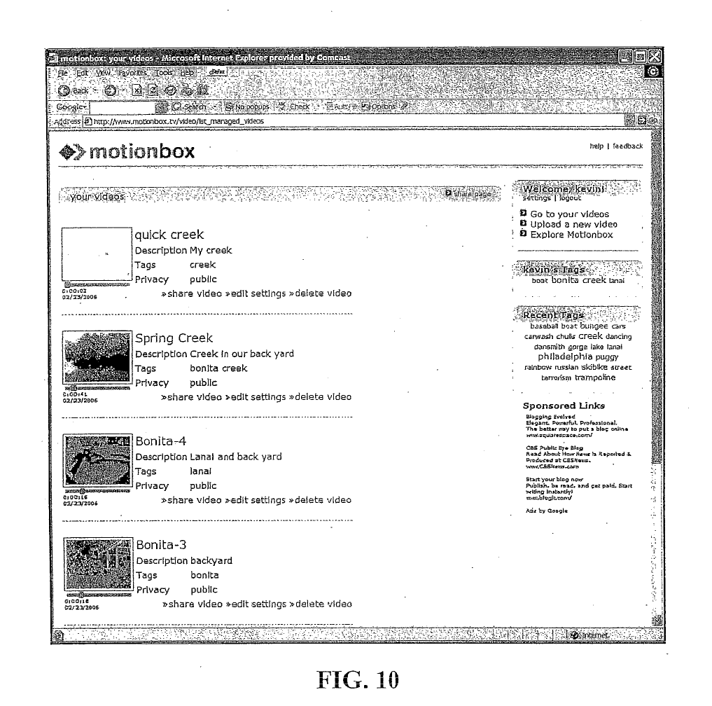

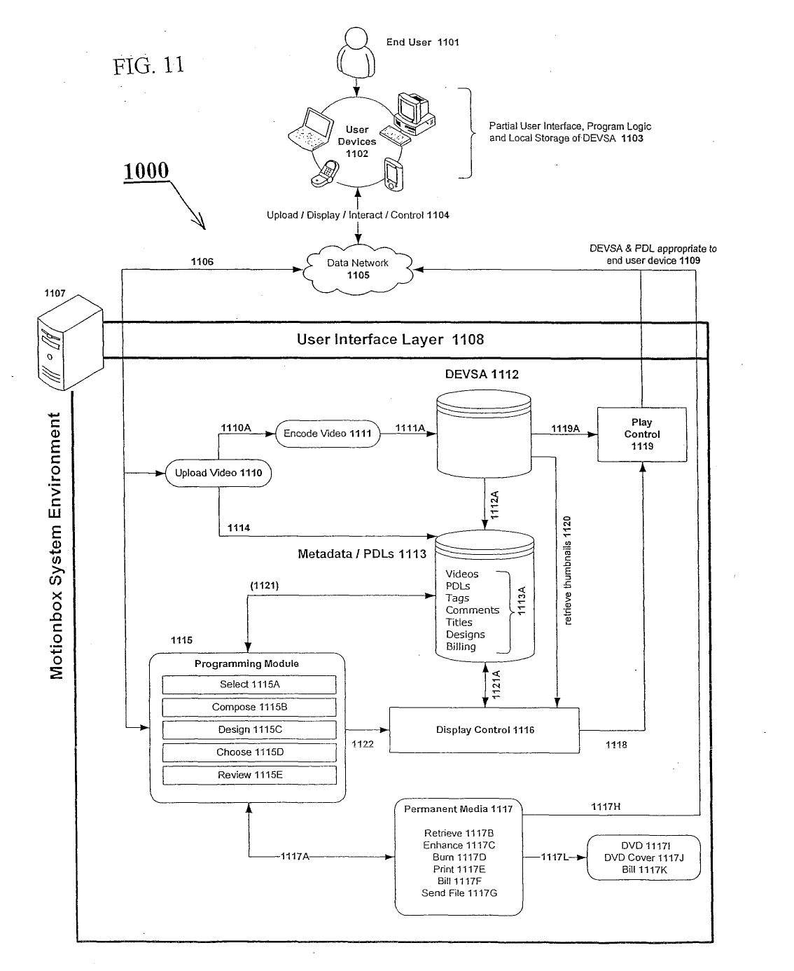

FIG. 11 is a flow diagram of a multi-user interactive system and data model for autogeneration of long-term media data from networked time-based media and interactive metadata.

### DETAILED DESCRIPTION OF THE PREFERRED EMBODIMENTS

Reference will now be made in detail to several embodiments of the invention that are illustrated in the accompanying drawings. Wherever possible, same or similar reference numerals are used in the drawings and the description to refer to the same or like parts or steps. The drawings are in simplified form and are not to precise scale. For purposes of convenience and clarity only, directional terms, such as top, bottom, up, down, over, above and below may be used with respect to the drawings. These and similar directional terms should not be construed to limit the scope of the invention in any manner. The words “connect,” “couple,” and similar terms with their inflectional morphemes do not necessarily denote direct and immediate connections, but also include connections through mediate elements or devices.

The present invention proposes a system including three major, enablingly-linked and alternatively engagable components, all driven from central server systems.
1. A series of user interfaces;
2. An underlying programming model and algorithms; and
3. A data model.

In a preferred mode all actual video manipulation is done on the server, but local servers, consumer devices, or other effective computer systems may be engaged for operation. The “desktop” or other user interface device needs only to operate Web browser software or the equivalent, a video & audio player which can meet the server's requirements and its own internal display and operating software and be linked to the servers via the Internet or another suitable data connection. As advances in consumer electronics permit, other implementations become feasible and are described in the last section. In those alternative implementations certain functions can migrate from the servers to end-user devices or to network-based devices without changing the basic design or intent of the invention.

### The User Interface

An important component of a successful video editing system is a flexible user interface which:
1. is consistent with typical user experience but not necessarily typical video editing user interfaces,
2. will not place undue burdens on the end-user's device, and
3. is truly linked to the actual DEVSA.

A major detriment to be overcome is that the DEVSA is a four dimensional entity which needs to be represented on a two dimensional visual display, a computer screen or the display of a handheld device such as a cell phone or an iPod®.

These proposals take the approach of creating an analog of a text document made up, not of a sequence of text characters, but of a sequence of “thumbnail” frame images at selected times throughout the video. For users who express the English language as a preference, these thumbnails are displayed from left to right in sequential rows flowing downward in much the way English text is displayed in a book. (Other sequences will naturally be more appropriate for users whose written language progresses in a different manner.) A useful point is to have the thumbnails and the “flow” of the video follow a sequence similar to that of the user's written language; such as left-to-right, top-to-bottom, or right-to-left. A selected frame may be enlarged and shown above the rows for easier viewing by the user. FIG. 7 shows an example.

As a further example, a 5 minute video might be initially displayed as 15 thumbnail images spaced about 20 seconds apart in time through the video. This user interface allows the user to quickly grasp the overall structure of the video. The choice of 15 images rather than some higher or lower number is initially set by the server administrator but when desired by the user can be largely controlled by the user as he/she is comfortable with the screen resolution and size of the thumbnail image.

By means of mouse (or equivalent) or keyboard commands, the user can “zoom in” on sub-sections of the video and thus expand to, for example, 15 thumbnails covering 1 minute of video so that the thumbnails are only separated by about 4 seconds. Whenever desired, the user can “zoom-in” or “zoom-out” to adjust the time scale to meet the user's current editing or viewing needs. One approach is the so-called “slider” wherein the user highlights a selected portion of the video timeline causing that portion to be expanded (zoomed-in) causing additional, more closely placed thumbnails of just that portion to be displayed. Additionally, other view modes can be provided, for example the ability to see the created virtual clip in frame (as described herein), clip (where each segment is shown as a single unit), or traditional video editing time based views.

Additional methods of displaying thumbnails over time can also be used to meet specific user needs. For example, thumbnails may also be generated according to video characteristics such as scene transitions or changes in content (recognized via video object recognition).

The user interfaces allow drag and drop editing of different video clips with a level of ease similar to that of using a word processing application such as Microsoft Word®, but entirely within a web browser. The user can remove unwanted sections of video or insert sections from other videos in a manner analogous to the cut/copy-and-paste actions done in text documents.

A noted previously, these “drag, drop, copy, cut, paste” edit commands are stored within the data model as metadata, do not change the underlying DEVSA data, and are therefore in clear contrast with the related art.

The edit commands, deep tags and synchronized commentary can all be externally time-dependent at the user's option. As an elementary example, “If this is played between March 29 and March 31, Play Audio: “HAPPY BIRTHDAY”. Ultimately, all PDLs may be externally time dependent if desired.

Other user interface representations of video streams on a two dimensional screen are also possible and could also be used without disrupting the editing capabilities described herein. One example is to arrange the page of thumbnail images in time sequence as if they were a deck of cards or a book thus creating an apparent three-dimensional object where the depth into the “deck of cards” or the “book” is a measure of time. Graphical “tabs” could appear on the cards or book pages (as on large dictionaries) which would identify the time (or other information) at that depth into the deck or book. The user could then “cut the deck” or “open the book” at places of his choosing and proceed in much the same way as described above. These somewhat different representations would not change the basic nature of the claims herein. There can be value in combining multiple such representations to aid users with diverse perception preferences or to deal with large quantities of information.

In the preceding it has been assumed that the “user” has the legal right to modify the display of the DEVSA, which may be arguably distinguished from a right to modify the DEVSA itself. There may be cases where there are users with more limited or more extensive rights. The user interface will allow the individual who introduces the video and claims full edit rights, subject to legal review, to limit or not to limit the rights of others to various viewing permissions and so-called “editing” functions (these are “modifying the display” edits noted earlier). These permissions can be adjusted within various sub-segments of the video. It is expected that the addition of deep tags and synchronized commentary by others will not generally be restricted in light of the fact that the underlying DEVSA is not compromised by these edit commands as is explained more fully below.

Before going further, and in order to fully appreciate the major innovation described in this and the related applications, it is necessary to introduce a new enabling concept which is referred to as the Playback Decision List or hereafter “PDL.” The PDL is a portion of metadata contained within a data model or operational system for manipulating related video data and for driving, for example, a flash player to play video data in a particular way without requiring a change in the underlying video data (DEVSA). This new concept of a PDL is best understood by considering its predecessor concepts that originated years ago in film production and are used today by expert film and video directors and editors.

The predecessor concept is an Edit Decision List or EDL. It is best described with reference to the production of motion pictures. In such a production many scenes are filmed, often several times each, in a sequence that has no necessary relationship to the story line of the movie. Similarly, background music, special effects and other add-ons are produced and recorded or filmed independently. Each of those film and audio elements is carefully labeled and timed with master lists.

When these master lists are complete, the film's director and editor sit down, often for a period of months, and review each element while gradually writing down and creating and revising an EDL which is a very detailed list, second by second, of which film sequences will be spliced together in what sequence perhaps with audio added to make up the entire film. Additionally, each sequence may have internal edits required such as fade-in/out, zoom-in/out, brighten, raise audio level and so on. The end result is an EDL. Technicians use the EDL to, literally in the case of motion picture, cut and paste together the final product. Some clips are just cut and “left on the cutting room floor”. Expert production of commercial video follows a very similar approach.

The fundamental point of an EDL is that one takes segments of film or video and audio and possibly other elements and links them together to create a new stream of film or video, audio, etc. The combining is done at the film or video level, often physically. The original elements very likely were cut, edited, cropped, faded in/out, or changed in some other manner and may no longer even exist in their original form.

This EDL technique has proven to be extremely effective in producing high quality film and video. It requires a substantial commitment of human effort, typically many staff hours per hour of final media and is immensely costly. It further requires that the media elements to be edited be kept in viewable/hearable form in order to be edited properly. Such an approach is economically impossible when dealing with large quantities of consumer-produced video. The PDL concept introduced herein provides a fundamentally different way to obtain a similar end result. The final “quality” of the video will depend on the skill and talent of the editor nonetheless.

The PDL incorporates as metadata associated with the DEVSA all the edit commands, deep tags, commentary, permissions, etc. introduced by a user via a user interface (as will be discussed). It is critical to recognize that multiple users may introduce edit commands, deep tags, synchronized commentary, permissions, etc. all related to the same DEVSA without changing the underlying video data. The user interface and the structure of the PDL allow a single PDL to retrieve data from multiple DEVSA.

The result is that a user can define, for example, what is displayed as a series of clips from multiple original videos strung together into a “new” video without ever changing the original videos or creating a new DEVSA file. Since multiple users can create PDLs against the same DEVSA files, the same body of original videos can be displayed in many different ways without the need to create new DEVSA files. These “new” videos can be played from a single or from multiple DEVSA files to a variety of end-user devices through the use of software and/or hardware decoders that are commercially available. For performance or economic reasons, copies or transcodings of certain DEVSA files may be created or new DEVSA files may be rendered from an edited segment, to better serve specific end-user devices without changing the design or implementation of the invention in a significant manner.

Since multiple types of playback mechanisms are likely to be needed such as one for PCs, one for cell phones and so on, the programming model will create a “master PDL” from which algorithms can create multiple variations of the PDL suitable for each of the variety of playback mechanisms as needed. The PDL executes as a set of instructions to the video player.

As discussed earlier, in certain cases it is advantageous to download an entire encoded file in a form suitable to a specific device type rather than stream a display in real time. In the “download” case, the system will create the file using the PDL and the DEVSA, re-encode for saving it in the appropriate format, and then send that file to the end-user device where it is stored until the user chooses to play it. This “download” case is primarily a change in the mode of delivery rather a fundamentally distinct methodology.

The crucial innovation introduced by PDL is that it controls the way the DEVSA is displayed and played to any specific user at any specific time. Multiple PDLs can exist for each DEVSA file and any PDL can control multiple DEVSA files. It is a control list for the DEVSA player (flash player/mp4 player/et al.). All commands (edits, sequences, deep tags, comments, permissions, etc.) are executed at playback time while the underlying DEVSA does not change. This makes the PDL in stark contrast to an EDL which is a set of instructions to create a new DEVSA out of previously existing elements.

Having completed the overall supporting discussion, reference is made now to FIG. 1, an architectural review of a system model 100 for improving manipulation and operations of video and time-based DEVSA data. It should be understood, that the term “video” is sometimes used below as a term of convenience and should be interpreted to mean DEVSA, or more broadly time-based media.

In viewing the technological architecture of system model 100, those of skill in the art will recognize that an end-user 101 may employ a range of known user device types 102 (such as PCs, cell phones, PDAs, iPods et al.) to create and view DEVSA/video data.

Devices 102 include a plurality of user interfaces, operational controls, video management requirements, programming logic, local data storage for diverse DEVSA formats, all represented via capabilities 103.

Capabilities 103 enable a user of a device 102 to perform multiple interaction activities 104 relative to a data network 105. These activities 104 are dependent upon the capacities 103 of devices 102, as well as the type of data network 105 (wireless, dial, DSL, secure, non-secure, etc.).

Activities 104 including upload, display, interact, control, etc. of video, audio and other data via some form of data network 105 suited to the user device in a manner known to those of skill in the art. The user's device 102, depending on the capabilities and interactions with the other components of the overall architecture system 100, will provide 103 portions of the user interface, program logic and local data storage.

Other functions are performed within the system environment represented at 107 which typically will operate on servers at central locations while allowing for certain functionality to be distributed through data network 105 as technology allows and performance and economy suggest without changing the architecture and processes as described herein.

All interactions between system environment 107 and users 101 pass through a user interface layer 108 which provides functionality commonly found on Internet or cell phone host sites such as security, interaction with Web browsers, messaging etc. and analogous functions for other end-user devices.

As discussed, the present system 100 enables user 101 to perform many functions, including uploading video/DEVSA, audio and other information from his end-user device 102 via data network 105 into system environment 107 via a first data path 106.

First data path 106 enables an upload of DEVSA/video via program logic upload process loop 110. Upload process loop 110 manages the uploading process which can take a range of forms.

For example, in uploading video/DEVSA from a cell phone, the upload process 110 can be via emailing a file via interactions 104 and data network 105. In a second example, for video captured by a video camera, the video may be transferred from the camera to the user's PC (both user devices 102) and then uploaded from the PC to system environment 107 web site via the Internet in real time or as a background process or as a file transfer. Physical transmission of media is also possible.

During system operation, after a successful upload via uploading process loop 110, each video is associated with a particular user 101 and assigned a unique user and upload and video identifier, and passed via pathway 110A to an encode video process system 111 where it is encoded into one or more standard forms as determined by the system administrators or in response to a user request. The encoded video/DEVSA then passes via conduit 111A to storage in the DEVSA storage files 112. At this time, the uploaded, encoded and stored DEVSA data can be manipulated for additional and different display (as will be discussed), without underlying change. As will be more fully discussed below, the present data system 100 may display DEVSA in multiple ways employing a unique player decision list (PDL) for tracking edit commands as metadata without having to re-save, and re-revise, and otherwise modify the initially saved DEVSA.

Additionally, and as can be viewed from FIG. 1, during the upload (105-106-110), encodation (110A-111), and storage (111A-112) processes stages of system 100; a variety of “metadata” is created about the DEVSA including user ID, video ID, timing information, encoding information including the number and types of encodings, access information, and many other types of metadata, all of which passes via communication paths 114 and 112A to the metadata/PDL storage facility (ies) 113. There may be more than one metadata/PDL storage facility. As will be later discussed, the PDL drives the software controller for the video player on the user device via display control 116/play control 119 (as will be discussed).

Such metadata will be used repeatedly and in a variety of combinations with other information to manage and display the DEVSA combined with the metadata and other information to meet a range of user requirements. The present system also envisions a controlled capacity to re-encode a revised DEVSA video data set without departing from the scope and spirit of the present invention.

It is expected that many users and others including system administrators will upload (over time) many DEVSA to system environment 107 so that a large library of DEVSA (stored in storage 112) and associated metadata (stored in storage 113) will be created by the process described above.

Following the same data path 106 users can employ a variety of functions generally noted by interaction with video module 115. Several types of functionalities 115A are identified as examples within interact with video module 115; including editing, visual browsing, commenting, social browsing, etc. Some of these functions are described in related applications. These functions include the user-controlled design and production of permanent DEVSA media such as DVDs and associated printing and billing actions 117 via a direct data pathway 117A, as noted. It should be noted that there is a direct data path between the DEVSA files 112 and the functions in 117 (not shown in the Figure for reasons of readability.)

Many of the other functions 115A are targeted at online and interactive display of video and other information via data networks. The functions 115 interact with users via communication path 106; and it should be recognized that functions 115A use, create, and store metadata 113 via path 121.

User displays are generated by the functions 115/115A via path 122 to a display control 116, which merges additional metadata via path 121A, thumbnails (still images derived from videos) from 112 via paths 120.

Thumbnail images are created during encoding process 111 and optionally as a real time process acting on the DEVSA without modifying the DEVSA triggered by one of the functions 115/115A (play, edit, comment, etc.).

Logically the thumbnails are part of the DEVSA, not part of the metadata, but they may be alternatively and adaptively stored as part of metadata in 113. An output of display control 116 passes via pathway 118 to play control 119 that merges the actual DEVSA from storage 112 via pathway 119A and sends the information to the data network 105 via pathway 109.

Since various end-user devices 102 have distinct requirements, multiple play control modules may easily be implemented in parallel to serve distinct device types. It is also envisioned, that distinct play control modules 119 may merge distinct DEVSA files of the same original video and audio with different encoding via 119A depending on the type of device being supported.

It is important to note that interactive functions 115/115A do not link directly to the DEVSA files stored at 112, only to the metadata/PDL files stored at 113. The display control function 116 links to the DEVSA files 112 only to retrieve still images. A major purpose of this architecture within system 100, is that the DEVSA, once encoded, is preferably not manipulated or changed—thereby avoiding the earlier noted concerns with repeated decoding, re-encoding and re-saving. All interactive capabilities are applied at the time of play control 119 as a read-only process on the DEVSA and transmitted back to user 110 via pathway 109.

Those with skill in the art should recognize that PDLs and other metadata as discussed herein can apply not only to real time playback of videos and other time-based media but also to the non-real-time playback of such media such as might be employed in the creation of permanent media such as DVDs.

Referring now to FIG. 2, in a manner similar to that discussed with FIG. 1, here an electronic system, integrated user interface, programming module and data model 200 describes the likely flows of information and control among various components noted therein. Again, as noted earlier, the term “video” is sometimes used below as a term of convenience and should be interpreted by those of skill in the art to mean DEVSA.

Here, an end-user 201 may optionally employ a range of user device types 202 such as PCs, cell phones, iPods etc. which provide user 201 with the ability to perform multiple activities 204 including upload, display, interact, control, etc. of video, audio and other data via some form of a data network 205 suited to the particular user device 202.

User devices 202, depending on their capabilities and interactions with the other components of the overall architecture for proper functioning, will provide local 203 portions of the user interface, program logic and local data storage, etc., as will also be discussed.

Other functions are performed within the proposed system environment 207 which typically operates on one or more servers at central locations while allowing for certain functionality to be distributed through the data network as technology allows and performance and economy suggest without changing the program or data models and processes as described herein.

As shown, interactions between system environment 207 and users 201 pass through a user interface layer 208 which provides functionality commonly found on Internet or cell phone host sites such as security, interaction with Web browsers, messaging etc. and analogous functions for other end-user devices.

As noted earlier, users 201 may perform many functions; including video, audio and other data uploading DEVSA from user device 202 via data network 205 into system environment 207 via data path 206.

An upload video module 210 provides program logic that manages the upload process which can take a range of forms. For video from a cell phone, the upload process may be via emailing a file via user interface 208 and data network 205. For video captured by a video camera, the video can be transferred from a camera to a user's PC and then uploaded from the PC to system environment 207 via the Internet in real time or as a background process or as a file transfer. Physical transmission of media is also possible.

During operation of system 200, and after successful upload, each video is associated with a particular user 201, assigned a unique identifier, and other identifiers, and passed via path 210A to an encode video process module 211 where it is encoded into one or more standard DEVSA forms as determined by system administrators (not shown) or in response to a particular user's requests. The encoded video data then passes via pathway 211A to storage in DEVSA storage files 212.

Within DEVSA files in storage 212, multiple ways of encoding a particular video data stream are enabled; by way of example only, three distinct ways 212B, labeled D_{A}, D_{B}, D_{c} are represented. There is no significance to the use of three as an example other than to illustrate that there are various forms of DEVSA encoding and to illustrate this diversity system 200 enables adaptation to any particular format desired by a user and/or specified by system administrators.

One or more of the multiple distinct methods of encoding may be chosen for a variety of reasons. Some examples are distinct encoding formats to support distinct kinds of end-user devices (e.g., cell phones vs. PCs), encoding to enhance performance for higher and lower speed data transmission, encoding to support larger or smaller display devices. Other rationales known for differing encodation forms are possible, and again would not affect the processes or system and model 200 described herein. A critical point is that the three DEVSA files 212B labeled D_{A}, D_{B}, D_{c} are encodings of the same video and synchronized audio using differing encodation structures. As a result, it is possible to store multiple forms of the same DEVSA file in differing formats each with a single encodation process via encodation video 211.

Consequent to the upload, encode, store processes a plurality of metadata 213A is created about that particular DEVSA data stream being uploaded and encoded; including user ID, video ID, timing information, encoding information, including the number and types of encodings, access information etc. which passes by paths 214 and 212A respectively to the metadata/PDL (playback decision list) storage facilities 213. Such metadata will be used repeatedly and in a variety of combinations with other information to manage and display the DEVSA combined with the metadata and other information to meet a range of user requirements.

Thus, as with the earlier embodiment shown in FIG. 1, those of skill in the art will recognize that the present invention enables a single encodation (or more if desired) but many metadata details about how the encoded DEVSA media is to be displayed, managed, parsed, and otherwise processed.

It is expected that many users and others including system administrators (not shown) will upload many videos to system environment 207 so that a large library of DEVSA and associated metadata will be created by the process described above.

Following the same data path 206, users 201 may employ a variety of program logic functions 215 which use, create, store, search, and interact with the metadata in a variety of ways a few of which are listed as examples including share metadata 215A, view metadata 215B, search metadata 215C, show video 215D etc. These data interactions utilize data path 221 to the metadata/PDL databases 213. A major functional portion of the metadata is Playback Decision Lists (PDLs) that are described in detail in other, parallel submissions, each incorporated fully by reference herein. PDLs, along with other metadata, control how the DEVSA is played back to users and may be employed in various settings.

As was shown in FIG. 1 many of the other functions in program logic box 215 are targeted at online and interactive display of video and other information via data networks. As was also shown in FIG. 1, but not indicated here, similar combinations of metadata and DEVSA can be used to create permanent media.

Thus, those of skill in the art will recognize that the present disclosure also enables a business method for operating a user interface 208.

It is the wide variety of metadata, including PDLs, created and then stored which controls the playback of video, not a manipulation of the underlying and encoded DEVSA data.

In general the metadata will not be dependent on the type of end-user device utilized for video upload or display although such dependence is not excluded from the present disclosure.

The metadata does not need to incorporate knowledge of the encoded DEVSA data other than its identifiers, its length in clock time, its particular encodings, knowledge of who is allowed to see it, edit it, comment on it, etc. No knowledge of the actual images or sounds contained within the DEVSA is required to be included in the metadata for these processes to work. While this point is of particular novelty, this enabling system 200 is more fully illustrative.

Such knowledge of the actual images or sounds contained within the DEVSA while not necessary for the operation of the current system enables enhanced functionalities. Those with skill in the art will recognize that such additional knowledge is readily obtained by means of techniques including voice recognition, image and face recognition as well as similar technologies. The new results of those technologies can provide additional knowledge that can then be integrated with the range of metadata discussed previously to provide enhanced information to users within the context of the present invention. The fact that this new form of information was derived from the contents of the encoded time-based media does not imply that the varied edit, playback and other media manipulation techniques discussed previously required any decoding and re-encoding of the DEVSA. Such knowledge of the internal contents of the encoded time-based media can be obtained by decoding with no need to re-encode the original video so the basic premises are not compromised.

User displays are generated by functions 215 via path 222 to display control 216 which merges additional metadata via path 221A, thumbnails (still images derived from videos) from DEVSA storage 212 via pathway 220. (Note that the thumbnail images are not part of the metadata but are derived directly from the DEVSA during the encoding process 211 and/or as a real time process acting on the DEVSA without modifying the DEVSA triggered by one of the functions 215 or by some other process.) Logically the thumbnails are part of the DEVSA, not part of the metadata stored at 213, but alternative physical storage arrangements are envisioned herein without departing from the scope and spirit of the present invention.

An output of display control 216 passes via pathways 218 to play controller 219, which merges the actual DEVSA from storage 212 via data path 219A and sends the information to the data network via 209. Since various end-user devices have distinct requirements, multiple play control modules may be implemented in parallel to serve distinct device types and enhance overall response to user requests for services.

Depending on the specific end-user device to receive the DEVSA, the data network it is to traverse and other potential decision factors such as the availability of remote storage, at playback time distinct play control modules will utilize distinct DEVSA such as files D_{A}, D_{B}, or D_{c} via 219A.

The metadata transmitted from display control 216 via 218 to the play control 219 includes instructions to play control 219 regarding how it should actually play the stored DEVSA data and which encoding to use.

The following is a sample of a PDL—playback decision—and a tracking of user decisions in metadata on how to display the DEVSA data. Note that two distinct videos (for example) are included here to be played as if they were one. A simple example of typical instructions might be:

### Instruction (Exemplary):

Play video 174569, encoding b, time 23 to 47 seconds after start:
Fade in for first 2 seconds—personal decision made for tracking as metadata on PDL.
Increase contrast throughout—personal decision made for PDL.
Fade out last 2 seconds—personal decision made for PDL.

Play video 174569, encoding b, time 96 to 144 seconds after start
Fade in for first 2 seconds—personal decision made for PDL.
Increase brightness throughout—personal decision made for PDL.
Fade out last 2 seconds—personal decision made for PDL.

Play video 174573 (a different video), encoding b, time 45 to 74 seconds after start
Fade in for first 2 seconds—personal decision for PDL.
Enhance color AND reduce brightness throughout, personal decision for PDL.
Fade out last 2 seconds—personal decision for PDL.

The playback decision list (PDLs) instructions are those selected using the program logic functions 215 by users who are typically, but not always, the originator of the video. Note that the videos may have been played “as one” and then have had applied changes (PDLs in metadata) to the visual video impression and unwanted video pieces eliminated. Nonetheless the encoded DEVSA has not been changed or overwritten, thereby minimizing risk of corruption, the expense of re-encoding has been avoided and a quick review and co-sharing of the same (or multiples of) video among multiple video editors and multiple video viewers has been enabled.

Much other data may be displayed to the user along with the DEVSA including metadata such as the name of the originator, the name of the video, the groups the user belongs to, the various categories the originator and others believe the video might fall into, comments made on the video as a whole or on just parts of the video, deep tags or labels on the video or parts of the video.

It is important to note that the interactive functions 215 for reviewing and using DEVSA data, do not link to the DEVSA files, only to the metadata files, it is the metadata files that back link to the DEVSA data. Thus, display control function 216 links to DEVSA files at 212 only to retrieve still images. A major purpose of this data architecture and data system 200 imagines that the DEVSA, once encoded via encodation module 211, is not manipulated or changed and hence speed and video quality are increased, computing and storage costs are reduced. All interactive capabilities are applied at the time of play control that is a read-only process on the DEVSA.

Those of skill in the art should recognize that in optional modes of the above invention each operative user may share their metadata with others, create new metadata, or re-use previously stored metadata for a particular encoded video.

Referring now to FIG. 3 an operative and editing system 300 comprises at least three major, linked components, including (a) central servers 307 which drive the overall process along a plurality of user interfaces 301 (one is shown), (b) an underlying programming model 315 housing and operatively controlling operative algorithms, and (c) a data model encompassing 312 and 313 for manipulating and controlling DEVSA and associated metadata.

Those of skill in the art should understand that all actual video manipulation is done on the server. Thus this concept depicted here envisions that a “desktop” or other user interface device need only to operate Web browser software and its own internal video player and display and operating software and be linked to servers 307 via the Internet or another suitable data network connection 305. Those of skill in the art should understand that the PDL produces a set of instructions for the components of the central system environment, any distributed portions thereof and end-user device video player and display. The PDL is generated on the server while the final execution of the instructions generally takes place on the end-user device.

As a consequence, the present discussion results in “edit-type commands” becoming a subset of the metadata described earlier.

Those of skill in the art should understand that while much of the discussion in this application is focused on video. The capabilities described herein apply equally to audio. They would also apply to many forms of graphic material, and certainly all graphic material which has been encoded in video format. Other than time-dependent functions (that is time internal to the DEVSA), they apply equally to photographic images and to text.

During operation, a user (not shown) interfaces with user interface layer 308 and system environment 307 via data network 305. A plurality of web screen shots 301 is represented as illustrated examples of the process of video image editing that is shown in greater detail with FIGS. 4 through 10.

During personal editing of content, a user (not shown) interacts with user interface layer 308 and transmits commands through data network 305 along pathway 306.

As shown a user has uploaded multiple, separate videos vid 1, vid 2, vid 3 using processes 310, 310′, 310″. Then via parallel processes 310 the three videos are encoded in process 311. In this example we show each video being encoded in two distinct formats (D_{vid1A}, D_{vid1B}) based either on system administration rules or on user requests. Via path 311A two encoded versions of each of the three videos is stored in 312 labeled respectively D_{vid1A} D_{vid1B} and so on where those videos of a specific user are retained and identified by user at grouping 312B.

It should be similarly understood that the initial uploading steps 310 for each of the videos generate related metadata and PDLs 313 transferred to a respective storage module 313, where each user's initial metadata is individually identified in respective user groupings 313A.

Those of skill in the art will understand that multiple upload and encode steps allow users to display, review, and edit multiple videos simultaneously. Additionally, it should be readily recognized that each successive edit or change by an individual is separately tracked for each respective video for each user. When editing multiple videos like this—or just one video—the user is creating a new PDL which is a new logical object which is remembered and tracked by the system.

As will be understood, videos may be viewed, edited, and updated in parallel with synchronized comments, deep tagging and identifying.

The present system enables social browsing of others' multiple videos with synchronized commenting for a particular single video or series of individual videos.

A display control 316 receives data via paths 312A and thumbnails via path 320 for initially driving play controller 319 via pathway 318.

As is also obvious from FIG. 3, an edit program model 315 (discussed in more detail below) receives user input via pathway 306 and metadata and PDLs via pathway 321.

The edit program model 315 includes a controlling communication path 322 to display control 316. As shown, the edit program model 315 consists of sets of interactive programs and algorithms for connecting the user's requests through the aforementioned user interfaces 308 to a non-linear editing system on server 307 which in turn is linked to the overall data model (312 and 313 etc.) noted earlier in-part through PDLs and other metadata.

Since multiple types of playback mechanisms are likely to be needed such as one for PCs, one for cell phones and so on, the edit program model 315 will create a “master PDL” from which algorithms can adaptively create multiple variations of the PDL suitable for each of the variety of playback mechanisms as needed. One such variation can be the selection which encoding version (e.g., D_{vid1A} or D_{vid1B}) to use for which type of end-user device. Here, the PDL is created by the edit program model and algorithms 315 that will also interface with the user interface layer 308 to obtain any needed information and, in turn, with the data model (See FIG. 2) which will store and manage such information.

The edit program model 315 retrieves information from the data model as needed and interfaces with the user interface layer 308 to display information to multiple users. Those of skill in the arts of electronic programming should also recognize that the edit program model 315 will also control the mode of delivery, streaming or download, of the selected videos to the end-user; as well as perform a variety of administrative and management tasks such as managing permissions, measuring usage (dependency controls, etc.), balancing loads, providing user assistance services, etc. in a manner similar to functions currently found on many Web servers.

As noted earlier the data model generally in FIGS. 1 and 2, manages the DEVSA and its associated metadata including PDLs. As discussed previously, changes to the metadata including the PDLs do not require and in general will not result in a change to the DEVSA. However for performance or economic reasons the server administrator may determine to make multiple copies of the DEVSA and to make some of the copies in a different format optimized for playback to different end-user device types. The data model noted earlier and incorporated here assures that links between the metadata associated with a given DEVSA file are not damaged by the creation of these multiple files. It is not necessary that separate copies of the metadata be made for each copy of the DEVSA; only the linkages must be maintained.

One PDL can reference and act upon multiple DEVSA. Multiple PDLs can reference and act upon a given DEVSA file. Therefore the data model takes special care to maintain the metadata to DEVSA file linkages.

Referring now to FIGS. 4-10, an alternative discussion of images 301 is discussed in order to demonstrate how the process can appear to the user in one example of how a user can “edit” DEVSA by changing the manner in which it is viewed without damaging the actual DEVSA as it is stored. In FIG. 4, a user has uploaded via upload modules 310A a series of videos that are individually characterized with a thumbnail image, initial deep tagging and metadata. The first page is shown.

In FIG. 5, options ask whether to add a video or action to a user's PDL (as distinguished from a user's EDL), and a user may simply click on a “add” indicator to do so. Multiple copies of the same video may be entered as well without limit.

In FIG. 6, a user has added and edited three videos of his or her choosing to the PDL and has indicated a “build” instruction to combine all selected videos for later manipulation.

In FIG. 7, an edit display page is provided and a user can see all three selected videos in successively arranged text-like formats with thumbnails via 320 equally spaced in time (roughly) throughout each video. Here 2 lines for the first 2 videos and 3 lines for the third video just based on length. Here at the beginning and end of each video there is a vertical bar signifying the same and a user may “grab” these bars using a mouse or similar device and move left-right within the limits of the videos. A thin bar (shown in FIG. 7 about 20% into the first thumbnail of the first video) also enables and shows where an image playback is at the present time and where the large image at the top is taken from. If the user clicks on PLAY above, the video will play through all three videos without a stop until the end thus joining the three short videos into one, all without changing the DEVSA data.

In FIG. 8, a user removes certain early frames in the second two videos to correct lighting and also adjusted lighting and contrast by using metadata tools. A series of sub-images may be viewed by grouping them and pressing “Play.”

In FIG. 9 the user has continued to edit his three videos into one continuous video showing his backyard, no bad lighting scenes, no boat, no “pool cage”. It is less than half the length of the original three, plays continuously and has no bad artifacts. The three selected videos will now play as one video in the form shown in FIG. 9. The user may now give this edited “video” a new name, deep tags, comments, etc. It is important to note that no new DEVSA has been created, what the user perceives as a new “video” is the original DEVSA controlled by new PDLs, and other metadata created during the edit session described in the foregoing. The user is now finished editing in this example.

In FIG. 10, a user has returned to the initial user video page where all changes have been made via a set of PDLs and tracked by storage module 313 for ready playing in due course, all without modifying the underlying DEVSA video. His original DEVSA are just as they were in FIG. 4.

The present invention provides a highly flexible user interface and such tools are very important for successful video editing systems. The invention is also consistent with typical user experience with Internet-like interactions, but not necessarily typical video editing user interfaces. The invention will not place undue burdens on the end-user's device, and the invention truly links actual DEVSA with PDL.

Referring now to FIG. 11 which is a flow diagram of a multi-user interactive system and data model for autogeneration of long-term media data from time-based media and interactive metadata, those of skill in the art will recognize that is of the same form and architecture as shown in FIG. 1 while it emphasizes functions and processes related to the current application.

This operative system comprises at least three major, linked components, all driven from central servers 1107 including (a) a plurality of user interfaces represented as user interface layer 1108 that is linked to a variety of end user devices 1102 used by end users 1101 (one is shown) via a plurality of data networks 1105 (one is shown), (b) an underlying programming model including the programming module 1115 operatively housing and controlling operative algorithms and programming, and (c) a data model or system encompassing operative modules 1112 and 1113 for manipulating and controlling stored, digitally encoded time-based media such as video and audio, DEVSA, and associated metadata.

Those of skill in the art should understand that, in the present embodiment, all actual video manipulation is done on the server. Thus, this concept depicted here envisions that a “desktop” or other user interface device need (at a minimum) only to operate Web browser software and its own internal video player and display and operating software linked to servers 1107 via the Internet or another suitable data network connection 1105. As an alternative embodiment those of skill in the art will recognize that the present system may be adapted to desktop operations under special circumstances where Internet access is not available or desirable or to “kiosk”-based operations, whether the kiosk is connected to central servers or not, if one chooses to establish operations in such a manner.

The extension of similar concepts and capabilities to end-user devices is non-trivial. The separation of metadata/PDLs from DEVSA which is not modified by deep tags, synchronized comments, visual browsing tools and social browsing tools enables a system, process and method to position databases in varied physical locations without varying their logical relationships.

Thus the operational and software architecture of FIG. 11 has a form similar to that described in earlier FIGS. 1, 2, and 3 but with the additional details noted herein. The primary details described herein are beyond those described in the related applications listed above as cross-references occur within modules 1115, 1117 and 1113 and their interactions. The roles, actions, and capabilities of upload video 1110, encode video 1111, display control 1160, play control 1119 and DEVSA storage module 1112 are similar to those described in the discussion of the previous Figures.

Those of skill in the art should recognize that the PDLs, synchronized tags and comments, and other metadata discussed herein and in the referenced applications are applied in this application not only to rendering interactive time-based media via networked connections but also to rendering such interactive time-based media in a manner such that it can be recorded onto to permanent media such as DVDs. The apparatus, processes and methods of uploading, encoding, storing and editing time-based media remain the same. The apparatus, processes and methods of synchronous tags, labels, comments, interest intensity, etc., similarly remain the same. What is introduced herein involves an additional set of apparatus, processes and methods to produce new kinds of outputs, specifically permanent media recordings incorporating the time-based media and the associated metadata and auxiliary materials such as paper covers which incorporate images, text derived from said media and metadata. In addition required business processes such as physical media creation, billing and shipping are included processes.

Those of skill in the art should further understand that while much of the discussion in this application is focused on video, the capabilities described herein apply equally to audio data. The capabilities would additionally apply to many forms of graphic material, and certainly all graphic material that has been encoded in video format. Other than time-dependent functions, these capabilities apply equally to photographic images, to graphics, and to text.

During operation of system 1100, a user 1101 interfaces with user interface layer 1108 and system environment 1107 via data network 1105 and pathway 1106. In a practical sense, a plurality of screen displays would be observed by the user 1101 as user 1101 interacts with the functions operably retained within programming module 1115 including (only a subset are listed) select 1115A videos to be included, compose 1115B titles for each video, design 1115C paper cover for DVD, choose 1115D tags and comments to be included and review 1115E DVD for approval prior to completion. These user interactions are discussed in further detail below.

During operation, as user 1101 interacts with the functionalities, features, and algorithms contained in programming module 1115, programming module 1115 interacts with metadata/PDL data storage 1113 both uploading information of user inputs and downloading information about the media and about other users' activities and information. The programming module 1115 also interacts with display control 1116 in the manner discussed previously to repeatedly create new displays of media in response to user inputs and according to algorithms and functionalities that respond to metadata (both new and previously stored). The user's activities are tracked, analyzed and stored in metadata/PDL storage module 1113 as metadata and linked to the appropriate videos, the internal time within those videos and such other data as may be needed to carry out the functions described herein.

When the user has completed the interactive processes 1115, a subsequent set of processes labeled permanent media 1117 begin. These processes are controlled by the programming module via link 1117A and may be viewed by those of skill in the art as a subset of the programming module in a computing architecture sense. These processes 1117 utilize data from 1112 and 1113 including data generated by the interactions 1115. Collectively that data is processed by a series of algorithms to produce a list of actions to be performed and then to execute those actions without human intervention in most cases other than handling physical media. Those actions include (not all actions are listed) retrieve 1117B time-based media from 1112 and metadata from 1113, enhance 1117C time-based media (if requested by user), burn 1117D DVD, print 1117E cover for DVD, bill 1117F user, and (optional) send file to user or other remote site via the network for burning DVD and printing cover at remote site such as user desktop or kiosk. This send file follows path 1117H to the external network and does not utilize the display control 1116 or play control 1119 functions. Additional functions to be performed include the physical processes of 11171 actually burning the DVD, 1117) printing the cover and 1117K printing a bill in the case where paper billing is required.

Those of skill in the art will recognize that the present disclosure enables at least the following commercial uses: 1. The invention is useful in a web-based personal video sharing system in which users can edit their own or other users' videos into new videos for sharing via the web site or via permanent media; 2. The system could be used with commercial content by consumers to make “mixes” of movies or music videos; and 3. Video journalists could quickly make a permanent record based on video they uploaded as well as stock footage from online libraries without damaging any of the original source materials.

The focus of the present invention consists of four major, linked components, all driven from the central servers: (1) a series of user interfaces (UI); (2). An underlying programming model (PM) and algorithms; (3) a data model (DM); and (4) a DVD (or analogous permanent medium) writing mechanism.

In the initial implementation of the present invention, all actual data manipulation and management is done on the servers and the DVD burning is done centrally.

The “desktop” or other user interface device needs only to operate Web browser or similar software and its own internal display and operating software and be linked to the servers via the Internet or another suitable data connection. As advances in consumer electronics permit, other implementations become feasible the present invention enables those alternative implementations to have certain functions that readily migrate from the servers to end user devices or to network-based devices without changing the basic design or intent of the invention.

The present invention allows resulting edits, titles, segment selection, tags, comments, etc. to become a subset of the metadata described in Applicant's data model application incorporated herein by reference above.

Much of the discussion herein is focused on video; however, the capabilities described herein apply equally to audio and shall be understood to so relate to audio. The discussions similarly apply to many forms of graphic material, certainly all graphic material which has been encoded in video format. Other than time dependent functions, they apply equally to photographic images and to text.

As discussed herein, the process to be followed and the action of the components during that process consists of three major phases and is best shown by working through a simple example of a consumer's interaction with the system and the system's subsequent operations. Let us refer to the consumer as “Ann.”

In the following the term DVD is meant to encompass other analogous permanent media types and serves a representative function only.

### Phase 1:

a. Ann employs the UI to list two videos Ann wants to include in the DVD: “roller” and “ice”. (We assume that Ann has permission to make copies of these two videos independent of whether Ann created these videos.)
b. The UI offers Ann the opportunity to enter a new title for each video for the DVD.
c. The UI allows Ann to choose to include
the entire video as originally loaded
the video as edited
only tagged segments
only very interesting segments as shown by the interest intensity measure discussed in the Social Browsing Patent.
   d. For each video, if Ann chooses only tagged segments, Ann then chooses which users' tags. For example, just her own, “friends and family”, all users, her roller skating club, all roller skating interest groups, or any other grouping Ann arranges.
   e. For each video, Ann then chooses to include or not to include comments which have been entered.
   f. If Ann chooses to include comments, then again Ann can choose whose comments to include in the same manner in which Ann chose whose tags to use.
   g. Ann can choose to have video and/or audio enhancements for the DVD.
   h. Her selections on all matters can be different for each video.
   i. Ann can choose the number of copies of the DVD Ann wants.
   j. Ann can then choose whether the DVD(s) should be burned centrally, on her own equipment, or at some third location.
   k. Ann can choose among possible cover arrangements including images, titles, etc. The cover can be printed centrally or, if she chooses, on her own equipment or at some third location.
   l. The UI will then present a review of her selections for her approval and a price if appropriate.
   m. Ann then gets to review, if she wishes, parts of or the entire DVD contents and change her selections if she desires. Because typical networked connections will not permit very high quality video transmission, the video Ann observes during this review may be of lower quality than that which will appear on the DVD.
   n. Billing processes will ensue as needed.

It is presumed for purposes of discussion herein that all of the above process results have been communicated between the user interface module and the data module by the programming module for operational success in a manner disclosed in the references incorporated by reference.

### Phase 2:

Once the Phase 1 transaction is complete, the PM will populate a set of scripts with blanks filled in by the results of Phase 1. Such scripts would include operations such as
Retrieve DEVSA for roller
Enhance video and audio
Extract segments tagged by members of user subset Ann:friends and family
Extract tags and comments as specified by Ann
And so on using all the input from Ann in Phase 1 linked to the metadata associated with the two videos.

It must be additionally recognized, that as described in the “Virtual Browse” Patent application referenced above PCT/US07/65534 filed Mar. 29, 2007 (Ref. Motio.P003PCT) which in turn claims priority from U.S. Prov. App. No. 60/787,393 filed Mar. 29, 2006 (Ref. Motio.P003), the entire contents of which are again incorporated herein by reference, “Tags” serve not only as labels of a segment but also as virtual edit devices in that a user can tag selected segments and then designate only tagged segments to be included in the video to be viewed. Thus, a user has “virtually edited” the video without changing the underlying DEVSA and without consciously thinking in terms of edit commands.

It will be further recognized of the present invention by those of skill in the art that, that these scripts readily enable the creation of an optional Table of Contents for the DVD wherein, in analogy to a book, the video titles Ann specified become Chapter titles and the tags become Section headings depending upon programming preferences. Titles, tags and comments become “Index” entries that provide an additional means for users of the DVD to find the content they wish to find. Future users of the DVD will consequently be able to select Chapter and Section and play just the selected section while seeing the tags and comments that had been entered. Hence the DVD viewer will see something much like what one would see from the web site or on a professionally-produced DVD. This creation of Tables of Content and Indices is made possible by the fact that the metadata such as tags and comments are synchronized with DEVSA and neither the DEVSA nor the metadata are modified by these processes. Thus Ann could create one DVD on Monday and then create a second, quite distinct DVD on Tuesday from the same original DEVSA files by means of selecting a distinct set of tags and comments as script elements.

If Ann selected video and audio enhancement, then the quality of the video and audio on the DVD will be higher than that obtainable from typical Internet connections.

As an additional thought introduced here, it is recognized that as the present invention also enables the concept of a “video album” as a resultant metadata construct that describes what might be burned onto a DVD, then prior to burning or concurrent with burning such a DVD (and even without creating such a DVD), one may enjoy these benefits of this creative construct by merely saving it in a form of “video album”. As a consequence, those of skill in the programming and video editing arts will recognize the enablement of one form of “video album” in addition to the autogeneration benefits discussed herein.

### Phase 3:

Following scripts using Phase 2 information the PM will burn DVD(s).
The PM will create a cover for DVD(s) using thumbnails from video segments and tags associated with thumbnails and titles entered by user following instructions of user entered in Phase 1.
The PM will cause shipment of the DVD(s) to addresses as specified by Ann.

While the Applicant recognizes that the linking of end-user devices to Internet-based services has been long and widely discussed as a means to enhance the viewing of video, Applicant finds those discussions generally speculative and non-specific because no clear mechanisms are proffered for detailed implementation especially on the time axis within the DEVSA. The introduction in this and related applications of the novel techniques of metadata/PDLs, deep tags, synchronized comments, visual browsing, social browsing including interest intensity as defined in detail in Applicant's referenced patents and discussed herein all tied to the time domain within the individual DEVSA and all without modifying the individual DEVSA, no matter how combined with other DEVSA, do provide the detailed mechanisms making realistic and implementable such interactions between end-user devices and Internet-based services.

As should be understood by those of skill in the art, the present autogeneration application can be applied in multiple implementation structures to perform functions such as those described in the above paragraphs:

A. The inventive system and method may be implemented as a web site employing a UI, PM and DM plus DVD (or analogous medium) writer such as described above and in related patent applications.
B. The inventive system and method may also be implemented as above, but with the exception that the web site manages and/or provides information to the consumer's desktop or other end-user device to burn the DVD or analogous medium. This option is possible in cases C, D and E below as well.
C. Similarly, the inventive system and method herein may be implemented with functionality primarily on end user devices with digital video recording capabilities (examples are digital video recorders or personal computers) wherein DEVSA arriving at the end user device could be tagged before it arrives with synchronous tags, comments, etc. regarding its content and the user could use the invention to control playback of the DEVSA in the manner described previously. The user also could add synchronized tags and comments or Fixed Comments and have all those sent via data networks to other users in a manner similar to that done on the Internet. Here, the DEVSA could be directly transferred to a local DVD burning device or be transmitted to a central device. If special video and/or audio enhancement is desired, transmission to a central device is likely to be necessary.
D. In yet another adaptation, the present invention may operate in a mixed implementation method, wherein DEVSA is delivered to end user devices via distinct networks or the same networks as synchronized tagging and synchronized commenting and non-synchronized commenting information. (E.g., DEVSA is delivered via cable TV, satellite or direct broadcast while tagging and commenting information is delivered and sent via the Internet. Due to the special capabilities of this invention, especially the logical separation of the metadata from the DEVSA, a unique identification of the DEVSA plus a well-defined time indicator within the DEVSA is adequate to allow the performance of the functions described herein.) In this present implementation the invention has the advantage of easy integration of traditional broadband video distribution technologies such as cable TV, satellite TV and direct broadcast with the information sharing capabilities of the Internet as enabled by the current invention. In this case the DEVSA could be directly transferred to a local DVD burning device or be transmitted to a central device. If special video and/or audio enhancement is desired, transmission to a central device is likely to be necessary.
E. In another adaptive embodiment, a mixed implementation of the invention as noted in ‘D’ above but with the addition that the end user devices such as a digital video recorder made available individual usage data such as view, fast forward, etc. as a function of time within each DEVSA and such usage data is made available to the programming module and data module for processing, analysis, and storage and display via the user interface. That usage data could pass via one or more data networks, direct from said end-user device or via another of the user's devices such as a PC linked to the Internet and hence to the server wherein operates the PM, etc. To the degree permitted by the DVR or similar device the PM could provide signals to control both playback and user interface displays generated by the DVR. The fundamental point is to make use of both the DEVSA storage and data gathering capabilities of many individual end user devices such as DVRs and, if available, their externally controlled playback and UI capabilities, while similarly making full use of the multiple user, statistical, centralized analysis and data management capabilities of the PM and DM as described above. In this case the DEVSA could be directly transferred to a local DVD burning device or be transmitted to a central device. If special video and/or audio enhancement is desired, transmission to a central device is likely to be necessary.

Those of skill in the art will recognize that a specific advantage to implementation mode “E” noted above, and to a lesser extent implementations “D” and “C,” is that a DVR user who might be (for example) the 10,000th viewer of a broadcast program has the advantage of all the experiences of the previous 9,999 viewers with regard to what parts of the show are interesting, exciting, boring, or whatever plus their synchronized comments on what was going on. This may have special benefit for use in kiosk-type implementations where users wish to create DVDs which contain multiple selections of music videos or shows.

Those of skill in the art should also recognize that the use of the phrase media is employed as both a singular noun and sometimes a plural noun within a sentence construction, depending upon the construction itself. Those of skill in the art will recognize that the use of media as singular/plural is readily understood from the language construction local thereto.

Those of skill in the art will additionally recognize, that while the encoding system discussed herein is adaptively linked with the respective system and electronic interface, it will be recognized that each user electronic device necessarily operates with a respective encoding system to achieve the initial time-based media before transmitting the same. Therefore, an alternative embodiment of the present invention will recognize an adaptation wherein the encoding system may be provided additionally by or only by the user electronic device, without departing from the scope and spirit of the present invention.

Additionally, those of skill in the art will readily recognize that the user interface as discussed herein may readily include a variety of access permission and security access protocols as known to those of skill in the art so as to enable the operation of secure-access sites for customer-users without departing from the spirit and scope of the present invention.

In the claims, means- or step-plus-function clauses are intended to cover the structures described or suggested herein as performing the recited function and not only structural equivalents but also equivalent structures. Thus, for example, although a nail, a screw, and a bolt may not be structural equivalents in that a nail relies on friction between a wooden part and a cylindrical surface, a screw's helical surface positively engages the wooden part, and a bolt's head and nut compress opposite sides of a wooden part, in the environment of fastening wooden parts, a nail, a screw, and a bolt may be readily understood by those skilled in the art as equivalent structures.

Having described at least one of the preferred embodiments of the present invention with reference to the accompanying drawings, it is to be understood that the invention is not limited to those precise embodiments, and that various changes, modifications, and adaptations may be effected therein by one skilled in the art without departing from the scope or spirit of the invention as defined in the appended claims.

What is claimed is:

1. An electronic system, for auto generation of long term media data from a plurality of networked time-based media by a plurality of users of respective said time-based media including at least a first user through at least one of a plurality of user interfaces, the electronic system comprising:
at least one user computerized electronic memory device enabling a manipulation of said time-based media including at least a first time-based media;
user interface means for receiving, for encoding, and for storing said at least first time-based media in at least a first initial encoded standard in an electronic system environment in a manner available to each of said plurality of users;
metadata system means for creating, storing, and managing at least a first layer of time-dependent metadata in a manner associated with at least said first initial encoded standard of each respective said encoded time-based media without modifying said at least first initial encoded standard of each respective said encoded time-based media, and in a manner associated with at least one interaction by one of said plurality of users;
time sequence means in said metadata system means for generating a time informational indicator enabling each said user to perceive a useful progression through time of said at least first encoded time-based media;
electronic interaction system means for enabling at least one of said plurality of users to interact respectively with one of said time-based media and said metadata system means for creating, storing, and managing said at least first layer of metadata, and to track and generate according to each said users interaction with respective ones of each said encoded time-based media a plurality of separately stored respective playback decision lists individually linked to respective ones of said plurality of users' interactions and each said time-based media;
said electronic interaction system means including means for enabling a plurality of display control modes and a plurality of play modes of each said encoded time-based media according to said respective playback decision lists of ones of said plurality of users; and
said electronic interaction system means for enabling each of said plurality of users to interact and to track and generate, further comprising:
means for enabling user interactions including means for enabling at least one user interaction selected from a group comprising:
an editing, a viewing of editing results, an accepting and rejection of at least a portion of said editing results, a virtual browsing, a segment viewing, a tagging, a deep tagging, a commenting, a synchronized commenting, a social browsing, a granting of permissions, a restricting of permissions, an enhancement of at least one of a visual and an audio aspect at least one of said plurality of time-dependent metadata, said separately stored respective playback decision lists, and said encoded time-based media, said plurality of time-based media, and creation of a long term media form each linked to respective said user interactions.

2. An electronic system, according to claim 1, wherein:
said means for enabling user interactions includes said means for enabling said enhancement of said at least one of said visual and an audio aspect of said at least one of said plurality time-dependent metadata and said plurality time-based media linked to respective said user interactions under according to said users decisions, wherein:
said enhancement includes at least one of a selection, a composition, a designing, a choosing, and a reviewing of at least one of said plurality of encoded time-based media, said plurality of said time-dependent metadata, and at least one of said stored playback decision lists.

3. An electronic system, according to claim 1, wherein:
said means for enabling user interactions includes said means for enabling said creation of said long term media form linked to respective said user interactions, wherein:
said creation of said long term media form includes at least one of a retrieval, an enhancement, a generation of a durable media storage, a printing, and a sending of at least one said plurality of encoded time-based media displayed according to at least one of said plurality of playback decision lists and incorporating linked time-dependent metadata.

4. An electronic system, according to claim 3, wherein
said long term media form includes at least a portion of one of said time-based media, related metadata associated with one of said individually established user playback decision lists, and an individually established user playback decision list, and
said means for enabling said creation further comprises:
an operational system;
said operational system including at least one of an electronic means for said generation of said durable media storage of said long term media, wherein said long term media includes at least said one of said time-dependent metadata, at least one user determined stored playback decision list, a copy of said initially encoded time-based media, said encoded and established metadata as modified by at least one of said user-established playback decision list, and an electronic instruction list transferable to one of said user computerized electronic memory devices for generation of said durable media storage on said user computerized electronic memory device and a computerized electronic device operated by said operational system of said electronic system.

5. An electronic system, according to claim 3, wherein:
said creation of said long term media includes a generation of a printed cover member for said durable media storage.

6. An electronic system, according to claim 4, wherein:
said retrieval includes means for said at least one of said plurality of users to select one of a plurality of previously stored long term media by said plurality of users and one of said playback decision lists generated by said plurality of users, wherein each said user of said plurality of users may optionally retrieve one of another user's and their own previously stored time-based media and employ said means for enabling user interactions to conduct an enhancement of at least one of a visual and an audio aspect at least one of said retrieved previously stored long term media.

7. An electronic system, according to claim 4, wherein:
said enhancement includes means for said at least one of said plurality of users to enhance of one a plurality of previously stored long term media by said plurality of users, wherein each said user of said plurality of users may optionally retrieve another user's or their own previously stored long term media and employ said means for enabling user interactions to conduct an enhancement of at least one of a visual and an audio aspect of at least one of said previously stored long term media.

8. An electronic system, according to claim 4, wherein:
said sending includes means for said at least one of said plurality of users to designate a stored long term media generated by any one of said plurality of users and to transmit said designated long term media by one of a printed copy, an recorded media copy, an file attachment copy on an e-mail, and an enabling of an access to a down-loadable version of said long term media.

9. An electronic system, according to claim 4, wherein:
said operational system further comprises at least one of a user invoicing module for invoicing said at least one user for operating said electronic system according to a use by said user, an electronic charging module for charging said at least one user for operating said electronic system according to said use by said user, and a deposit account accessing module for debiting an account of said at least one user according to said use by said user.

10. An electronic system, according to claim 2, wherein:
said at least one enhancement involving said at least one of said selection, said composition, said designing, said choosing, and said reviewing of at least one of said plurality of stored playback decision lists, said of said time-dependent metadata, and said plurality of encoded time-based media, further including at least one of an addition of a title, comments, labels for at least an entire one or a sub-segment of said at least one.

11. An electronic system, according to claim 2, wherein:
said at least one enhancement further includes at least one of a means for manipulating one of a lighting transition, a visual effects processing, a visual interpolation, a sound editing, a sound manipulation, and sound transition of at least an entire one or a sub-segment of one of said time-dependent metadata and said time-based media.

12. An electronic system, for autogeneration of long term media data from a plurality of networked time-based media by a plurality of users of respective said time-based media including at least a first user through at least one of a plurality of user interfaces, the electronic system comprising:
at least one user computerized electronic memory device enabling a manipulation of said time-based media including at least a first time-based media;
user interface means for receiving, for encoding, and for storing said at least first time-based media in at least a first initial encoded standard in an electronic system environment in a manner available to each of said plurality of users;
metadata system means for creating, storing, and managing at least a first layer of time-dependent metadata in a manner associated with at least said first initial encoded standard of each respective said encoded time-based media without modifying said at least first initial encoded standard of each respective said encoded time-based media, and in a manner associated with each said plurality of users' interactions;
time sequence means in said metadata system means for generating a time informational indicator enabling each said user to perceive a useful progression through time of said at least first encoded time-based media;
electronic interaction system means for enabling each of said plurality of users to interact respectively with said metadata system means for creating, storing, and managing said at least first layer of metadata, and to track and generate according to each said user's interaction with respective ones of each said encoded time-based media a plurality of separately stored respective playback decision lists individually linked to respective ones of said plurality of users' interactions, said time-dependent metadata, and said previously created and stored other user's playback decision lists;
said electronic interaction system means including means for enabling a plurality of display control modes and a plurality of play modes of each said encoded time-based media according to said respective playback decision lists of ones of said plurality of users; and
said electronic interaction system means for enabling each of said plurality of users to interact and to track and generate, further comprising:
means for enabling user interactions including means for enabling at least one user interaction selected from a group of interactions, comprising: an enhancement of at least one of a visual and an audio aspect at least one of said plurality of time-based media, and a creation of a long term media form linked to respective said user interactions.

13. An operational system, for autogeneration of long term media data from a plurality of networked time-based media by a plurality of users of respective said time-based media including at least a first user through at least one of a plurality of user interfaces, the operational system comprising:
means for receiving via a user interface system a user-transferred time-based media in an electronic operational environment including at least one electronic memory device and said user interface system;
means for encoding an uploaded time-based media and for storing and encoding said uploaded time-based media in a first initial encoded standard
metadata creating means for creating, storing, and managing at least a first layer of time-dependent metadata in a manner associated with at least said first initial encoded standard of each respective said encoded time-based media without modifying said at least first initial encoded standard of each respective said encoded time-based media;
means for providing a time informational indicator enabling each said user to perceive a useful progression through time of said at least first encoded time-based media;
electronic interaction system enabling said at least one user to interact with and modify said established metadata associated with said encoded time-based media in at least a first stored playback decision list via a communication path including said user interface system, whereby each respective and separately stored said stored playback decision list of said at least one user of said plurality of users modifies said respective established metadata without modifying said encoded time-based media in said initial state;
said electronic interaction system including a display control means and a play control means enabling each one of said plurality of users to display and play said encoded time-based media in a modified manner according to each respective said one user's respective playback decision list without modifying said encoded time-based media; and
said electronic interaction system including at least one of a programming module means for conducting one of a selection, a comparison, a design, a choosing, and a reviewing of at least one of said stored user playback decision lists, said time-dependent metadata, and said time-based media, and a long term media form establishing means for conducting at least one of a retrieval, an enhancement, a storage, a sending, a printing, and a commercial transaction involving at least one of said user playback decision lists, said time-dependent metadata, and said time-based media.

14. An operational system, according to claim 13, wherein:
said electronic interaction system includes both said programming module means and said long term media form establishing means, whereby said operational system enables an enhanced use of said time-based media.

15. An operational system, according to claim 13, wherein:
said electronic interaction system includes said programming module means; and
said electronic interaction system enables any one said plurality of users to conduct at least one of said selection, said comparison, said design, said choosing, and said reviewing of said at least one of said user playback decision lists, said time-dependent metadata, and said time-based media, as previously determined by any of said others of said plurality of users, whereby said programming module means enables an enhancement of at least one of a visual and an audio aspect of said at least one time-based media.

16. An operational system, according to claim 15, wherein:
said electronic interaction system enables said enhancement; and
said enhancement includes at least one of a lighting transition, a visual effects processing, a visual effects editing, a visual interpolation, a sound editing, a sound manipulation, and a sound transition.

17. An operational system, according to claim 13, wherein:
said electronic interaction system includes said long term media form establishing means; and
said electronic interaction system enables any one of said plurality of users to conduct at least one of said retrieval, said enhancement, said sending, said storage, said printing, and said commercial transactions involving at least one of said user playback decision lists, said time-dependent metadata, and said time-based media.

18. An operational system, according to claim 17, wherein:
said commercial transaction involving said at least one enables said commercial transactions;
said commercial transactions involving said at least one is selected from a group of commercial transactions comprising: an invoicing of one of said user's use of said retrieval, said enhancement, said sending, said storage, said printing, and said operational system; a charging for said user's use of at least one of said retrieval, said enhancement, said sending, said storage, said printing, and said operational system; and a debit account accessing for accessing a user's debit account for said user's use of at least one of said retrieval, said enhancement, said sending, said storage, said printing, and said operational system.

19. An operational system, for autogeneration of long term media data from a plurality of networked time-based media by a plurality of users of including at least a first user through at least one of a plurality of user interfaces, the operational system comprising:
at least one user computerized electronic memory device enabling a manipulation of said time-based media including at least a first time-based media;
user interface means for receiving, for encoding, and for storing said at least first time-based media in at least a first initial encoded state in an electronic system environment in a manner available to each of said plurality of users;
metadata system means for creating, storing, and managing at least a first layer of time-dependent metadata in a manner associated with at least said first initial encoded state of each respective said encoded time-based media without modifying said at least first initial encoded state of each respective said encoded time-based media, and in a manner associated with an interaction of each said plurality of users;
time sequence means in said metadata system means for generating a time informational indicator enabling each said user to perceive a useful progression through time of said at least first encoded time-based media;
electronic interaction system means for enabling each of said plurality of users to interact with said metadata system means for creating, storing, and managing said at least first layer of metadata, and to track and generate according to each said user's interaction with respective ones of each said encoded time-based media a plurality of separately stored playback decision lists individually linked to one of respective ones of said plurality of users' interactions, said time-dependent metadata, and said previously created and stored other user playback decision lists;
said plurality of separately stored playback decision lists being accessible to others of said plurality of users;
said electronic interaction system means including means for enabling a plurality of display control modes and a plurality of play modes of each said encoded time-based media according to said respective playback decision lists; and
said electronic interaction system means, further comprising:
means for enabling user interactions including means for enabling at least one user interaction selected from a group comprising: an enhancement of at least one of a visual and an audio aspect at least one of said plurality of time-based media and creation of a long term media form each linked to respective said user interactions.

20. A method for providing autogeneration of long term media data from a plurality of networked time-based media by a plurality of users of said time-based media including at least a first user through at least one of a plurality of user interfaces, the method comprising the steps of:
providing at least one user computerized electronic memory device enabling a manipulation of said time-based media including at least a first time-based media;
enabling user interface means for receiving, for encoding, and for storing said at least first time-based media in at least a first initial encoded standard in an electronic system environment in a manner available to each of said plurality of users;
operating metadata system means for creating, storing, and managing at least a first layer of time-dependent metadata in a manner associated with at least said first initial encoded standard of each respective said encoded time-based media without modifying said at least first initial encoded standard of each respective said encoded time-based media, and in a manner associated with each of said plurality of users' interactions;
providing time sequence means in said metadata system means for generating a time informational indicator enabling each said user to perceive a useful progression through time of said at least first encoded time-based media;
operating electronic interaction system means for enabling each of said plurality of users to interact respectively with said metadata system means for creating, storing, and managing said at least first layer of metadata, and to track and generate according to each said user's interaction with at least one of said encoded time-based media, a plurality of separately stored respective playback decision lists linked to respective ones of said plurality of users' interactions, and said metadata,
said electronic interaction system means including means for enabling a plurality of display control modes and a plurality of play modes of each said encoded time-based media according to said respective playback decision lists of ones of said plurality of users; and
said electronic interaction system means for enabling each of said plurality of users to interact and to track and generate, further comprising:
means for enabling user interactions including means for enabling at least one user interaction selected from a group of interactions, comprising: an enhancement of at least one of a visual and an audio aspect at least one of said plurality of time-based media, and a creation of a long term media form linked to respective said user interactions.

21. A method for providing autogeneration of long term media data from a plurality of networked time-based media by a plurality of users of said time-based media including at least a first user through at least one of a plurality of user interfaces, the method comprising the steps of:
providing at least one user computerized electronic memory device enabling a manipulation of said time-based media including at least a first time-based media;
enabling user interface means for receiving, for encoding, and for storing said at least first time-based media in at least a first initial encoded standard in an electronic system environment in a manner available to each of said plurality of users;
operating metadata system means for creating, storing, and managing at least a first layer of time-dependent metadata in a manner associated with at least said first initial encoded standard of each respective said encoded time-based media without modifying said at least first initial encoded standard of each respective said encoded time-based media, and in a manner associated with each said plurality of users interactions;
providing time sequence means in said metadata system means for generating a time informational indicator enabling each said user to perceive a useful progression through time of said at least first encoded time-based media;
operating electronic interaction system means for enabling each of said plurality of users to interact respectively with said metadata system means for creating, storing, and managing said at least first layer of metadata, and to track and generate according to each said user's interaction with respective ones of each said encoded time-based media, a plurality of separately stored respective playback decision lists individually linked to respective ones of said plurality of users' interactions, and said time-dependent metadata,
said electronic interaction system means including means for enabling a plurality of display control modes and a plurality of play modes of each said encoded time-based media according to said respective playback decision lists of ones of said plurality of users; and
said electronic interaction system means for enabling each of said plurality of users to interact and to track and generate, further comprising: at least one of a programming module means for conducting one of a selection, a comparison, a design, a choosing, and a reviewing of at least one of said stored user playback decision lists, said time-dependent metadata, and said time-based media, and a long term media form establishing means for conducting at least one of a retrieval, an enhancement, a storage, a sending, a printing, and a commercial transaction involving at said least one of said user playback decision lists, said time-dependent metadata, and said time-based media.
